(19) United States
(12) Patent Application Publication
(10) Pub. No.: US 2026/0270335 A1
(43) Pub. Date: Sep. 10, 2026

(54) SLIDABLE ELECTRONIC DEVICE AND METHOD THEREFOR

(71) Applicant: Samsung Electronics Co., Ltd., Suwon-si (KR)

(72) Inventors: Sookyung LEE, Suwon-si (KR); Sangyun LEE, Suwon-si (KR); Sangheon KIM, Suwon-si (KR); Yeunwook LIM, Suwon-si (KR)

(21) Appl. No.: 19/662,681

(22) Filed: Apr. 29, 2026

Related U.S. Application Data
(63) Continuation of application No. PCT/KR2024/013355, filed on Sep. 4, 2024.

(30) Foreign Application Priority Data
Nov. 3, 2023 (KR) 10-2023-0151249
Dec. 26, 2023 (KR) 10-2023-0191954

(51) Int. Cl. H04M 1/02; H04M 1/72454

(52) U.S. Cl. CPC H04M 1/0268; H04M 1/0235; H04M 1/72454; H04M 2201/38

(57) ABSTRACT

A slidable electronic device is provided. The slidable electronic device includes memory, including one or more storage media, storing instructions, a housing including a first housing part and a second housing part that is movably engaged with the first housing part, an actuator configured to move the second housing part with respect to the first housing part, a flexible display coupled to the first housing part and the second housing part such that the size of an area, which is visible from the front side of the housing, changes as the second housing part is moved with respect to the first housing part, and one or more processors communicatively coupled to the memory, wherein the instructions, when executed by the one or more processors individually or collectively, cause the slidable electronic device to receive an input for extending the area, while a screen is displayed on the area, control, in response to the input, the actuator to move the second housing part with respect to the first housing part, and cause, while the area is extended in accordance with the second housing part being moved with respect to the first housing part in response to the input, the flexible display to change a refresh rate of the screen that is extended on the area, according to a rate at which the area is extended.

### CROSS-REFERENCE TO RELATED APPLICATION(S)

This application is a continuation application, claiming priority under 35 U.S.C. § 365(c), of an International application No. PCT/KR2024/013355, filed on Sep. 4, 2024, which is based on and claims the benefit of a Korean patent application number 10-2023-0151249, filed on Nov. 3, 2023, in the Ministry of Intellectual Property (MOIP), and of a Korean patent application number 10-2023-0191954, filed on Dec. 26, 2023, in the Ministry of Intellectual Property (MOIP), the disclosure of each of which is incorporated by reference herein in its entirety.

### BACKGROUND

### 1. Field

The disclosure relates to a slidable electronic device and a method thereof.

### 2. Description of Related Art

An electronic device including a flexible display such as a rollable display may provide a state in which a portion of the flexible display is inserted into a housing of the electronic device and a state in which the portion of the flexible display is exposed outside the housing. The electronic device may provide a relatively wide display area while having a relatively compact structure through providing the states.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a slidable electronic device and a method thereof.

Additional aspects will be set forth in part in the description which follows and, in part, will be apparent from the description, or may be learned by practice of the presented embodiments.

In accordance with an aspect of the disclosure, a slidable electronic device is provided. The slidable electronic device comprises memory, including one or more storage media, storing instructions, a housing including a first housing part and a second housing part that is movably engaged with the first housing part, an actuator configured to move the second housing part with respect to the first housing part, a flexible display coupled to the first housing part and the second housing part such that a size of an area of the flexible display that is visible from a front side of the housing changes as the second housing part is moved with respect to the first housing part, and one or more processors communicatively coupled to the memory, wherein the instructions, when executed by the one or more processors individually or collectively, cause the slidable electronic device to receive an input for extending the area, while a screen is displayed on the area, control, in response to the input, the actuator to move the second housing part with respect to the first housing part, cause, while the area is extended in accordance with the second housing part being moved with respect to the first housing part in response to the input, the flexible display to change a refresh rate of the screen that is extended on the area, according to a rate at which the area is extended.

In accordance with another aspect of the disclosure, a method executed in a slidable electronic device comprising a housing including a first housing part and a second housing part that is movably engaged with the first housing part, an actuator configured to move the second housing part with respect to the first housing part, and a flexible display coupled to the first housing part and the second housing part such that a size of an area of the flexible display that is visible from a front side of the housing changes as the second housing part is moved with respect to the first housing part is provided. The method comprises receiving an input for extending the area, while a screen is displayed on the area, controlling, in response to the input, the actuator to move the second housing part with respect to the first housing part, and while the area is extended in accordance with the second housing part being moved with respect to the first housing part in response to the input, changing a refresh rate of the screen that is extended on the area, according to a rate at which the area is extended.

In accordance with another aspect of the disclosure, one or more non-transitory computer readable storage media storing one or more computer programs including computer-executable instructions that, when executed by one or more processors of a slidable electronic device including a housing including a first housing part and a second housing part that is movably engaged with the first housing part, an actuator configured to move the second housing part with respect to the first housing part, and a flexible display coupled to the first housing part and the second housing part such that a size of an area of the flexible display that is visible from a front side of the housing changes as the second housing part is moved with respect to the first housing part, individually or collectively, cause the slidable electronic device to perform operations are provided. The operations include receiving an input for extending the area, while a screen is displayed on the area, controlling, in response to the input, the actuator to move the second housing part with respect to the first housing part, and causing, while the area is extended in accordance with the second housing part being moved with respect to the first housing part in response to the input, the flexible display to change a refresh rate of the screen that is extended on the area, according to a rate at which the area is extended.

In accordance with another aspect of the disclosure, a slidable electronic device is provided. The slidable electronic device comprises memory, including one or more storage media, storing instructions, a housing including a first housing part and a second housing part that is movably engaged with the first housing part, an actuator configured to move the second housing part with respect to the first housing part, a flexible display coupled to the first housing part and the second housing part such that a size of an area of the flexible display that is visible from a front side of the housing changes as the second housing part is moved with respect to the first housing part, and one or more processors communicatively coupled to the memory, wherein the instructions, when executed by the one or more processors individually or collectively, cause the slidable electronic device to receive, while a screen is displayed on the area having a first size, an input for changing a size of the area from the first size to a second size larger than the first size, in response to the input received while the screen is displayed on the area with a first refresh rate control the actuator to move the second housing part with respect to the first housing part such that the change from the first size to the second size is completed during a first time, and in response to the input received while the screen is displayed on the area with a second refresh rate higher than the first refresh rate, control the actuator to move the second housing part with respect to the first housing part such that the change from the first size to the second size is completed during a second time shorter than the first time.

In accordance with another aspect of the disclosure, a method executed in a slidable electronic device including a housing including a first housing part and a second housing part that is movably engaged with the first housing part, an actuator configured to move the second housing part with respect to the first housing part, and a flexible display coupled to the first housing part and the second housing part such that a size of an area of the flexible display that is visible from a front side of the housing changes as the second housing part is moved with respect to the first housing part is provided. The method comprises receiving, while a screen is displayed on the area having a first size, an input for changing a size of the area from the first size to a second size larger than the first size, controlling the actuator to move the second housing part with respect to the first housing part such that the change from the first size to the second size is completed during a first time, in response to the input received while the screen is displayed on the area with a first refresh rate, and controlling the actuator to move the second housing part with respect to the first housing part such that the change from the first size to the second size is completed during a second time shorter than the first time, in response to the input received while the screen is displayed on the area with a second refresh rate higher than the first refresh rate.

In accordance with another aspect of the disclosure, one or more non-transitory computer-readable storage media storing one or more computer programs including computer-executable instructions that, when executed by one or more processors a slidable electronic device including a housing including a first housing part and a second housing part that is movably engaged with the first housing part, an actuator configured to move the second housing part with respect to the first housing part, and a flexible display coupled to the first housing part and the second housing part such that a size of an area of the flexible display that is visible from a front side of the housing changes as the second housing part is moved with respect to the first housing part, individually or collectively, cause the slidable electronic device to perform operations are provided. The operations include receiving, while a screen is displayed on the area having a first size, an input for changing a size of the area from the first size to a second size larger than the first size, The controlling the actuator to move the second housing part with respect to the first housing part such that the change from the first size to the second size is completed during a first time, in response to the input received while the screen is displayed on the area with a first refresh rate, and controlling the actuator to move the second housing part with respect to the first housing part such that the change from the first size to the second size is completed during a second time shorter than the first time, in response to the input received while the screen is displayed on the area with a second refresh rate higher than the first refresh rate.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an electronic device extending an area of a display visible from a front side of a housing in response to an input according to an embodiment of the disclosure;

FIG. 2A is a top plan view of an electronic device in a first state according to an embodiment of the disclosure;

FIG. 2B is a bottom view of an electronic device in a first state according to an embodiment of the disclosure;

FIG. 2C is a top plan view of an electronic device in a second state according to an embodiment of the disclosure;

FIG. 2D is a bottom view of an electronic device in a second state according to an embodiment of the disclosure;

FIGS. 3A and 3B are exploded perspective views of an electronic device according to various embodiments of the disclosure;

FIG. 4A is a cross-sectional view of an electronic device in a first state according to an embodiment of the disclosure;

FIG. 4B is a cross-sectional view of an electronic device in a second state according to an embodiment of the disclosure;

FIG. 5 is a simplified block diagram of an electronic device according to an embodiment of the disclosure;

FIG. 6 is a flowchart illustrating a method for changing a refresh rate of a screen extended on an area to a rate at which the area is extended, while the area is extended according to an embodiment of the disclosure;

FIG. 7 illustrates an example of a screen displayed with a refresh rate changed to a rate at which an area is extended, while the area is extended according to an embodiment of the disclosure;

FIGS. 8A and 8B illustrate an example of a refresh rate changed to a rate at which an area is extended according to various embodiments of the disclosure;

FIG. 9 illustrates a method for changing a refresh rate according to an embodiment of the disclosure;

FIG. 10 is a flowchart illustrating a method for gradually changing a refresh rate lower than a reference refresh rate before an area is extended according to an embodiment of the disclosure;

FIG. 11 is a flowchart illustrating a method for changing a refresh rate of a screen extended on an area to a rate at which the area is extended and an illuminance around an electronic device, while the area is extended according to an embodiment of the disclosure;

FIG. 12 is a flowchart illustrating a method for maintaining a refresh rate while an area is reduced according to an embodiment of the disclosure;

FIG. 13A is a flowchart illustrating a method for controlling an actuator to extend an area to a refresh rate of a screen according to an embodiment of the disclosure;

FIG. 13B illustrates a method for determining a rate at which an area is extended to a state of an electronic device according to an embodiment of the disclosure;

FIG. 14 is a flowchart illustrating a method for controlling an actuator and a display based on checking a refresh rate of a screen higher than a reference refresh rate, while an area is extended according to an embodiment of the disclosure;

FIG. 15 is a flowchart illustrating a method for controlling an actuator independently of a refresh rate, while an area is reduced according to an embodiment of the disclosure;

FIG. 16 illustrates an example of an operation executed in an electronic device including a housing including a first housing part and a second housing part movably coupled to the first housing part according to an embodiment of the disclosure; and

FIG. 17 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

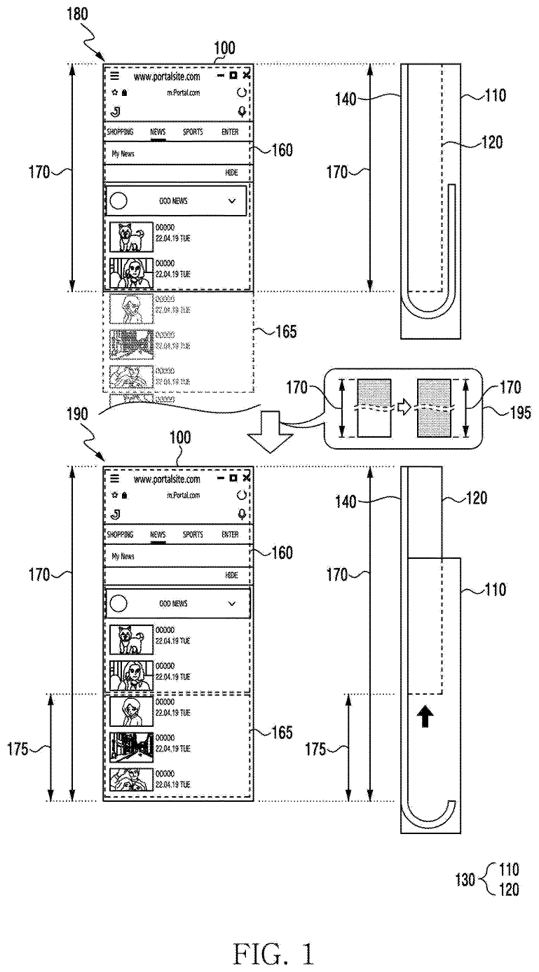

FIG. 1 illustrates an example of an electronic device extending an area of a display visible from a front side of a housing in response to an input according to an embodiment of the disclosure.

Referring to FIG. 1, an electronic device 100 (e.g., a slidable electronic device 100 or a rollable electronic device 100) may include a housing 130 and a display 140.

The housing 130 may include a first housing part 110 and a second housing part 120 movably engaged with the first housing part 110.

The display 140 may be a flexible display or a deformable display. An area visible from a front side of the housing 130 may be defined or formed in the display 140. For example, the display 140 may be coupled to the first housing part 110 and the second housing part 120 such that a size of the area is changed as the second housing part 120 is moved with respect to the first housing part 110. The area may be referred to as a display area.

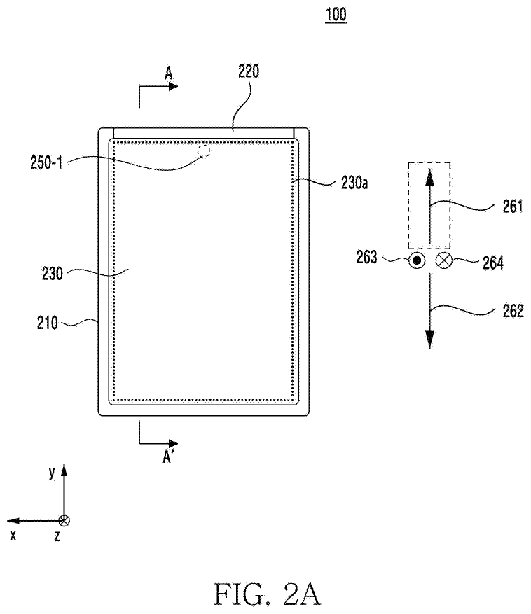

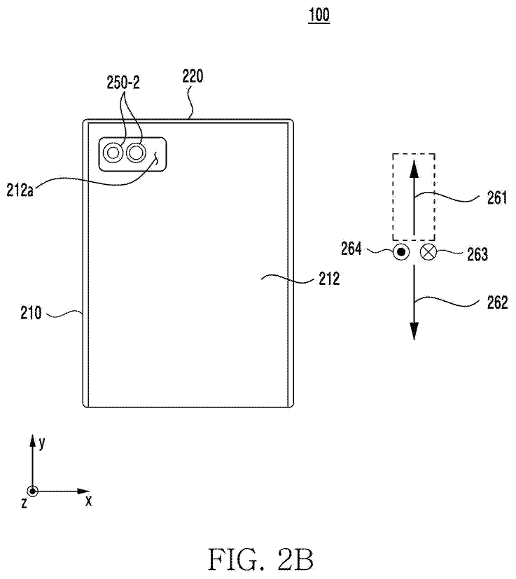

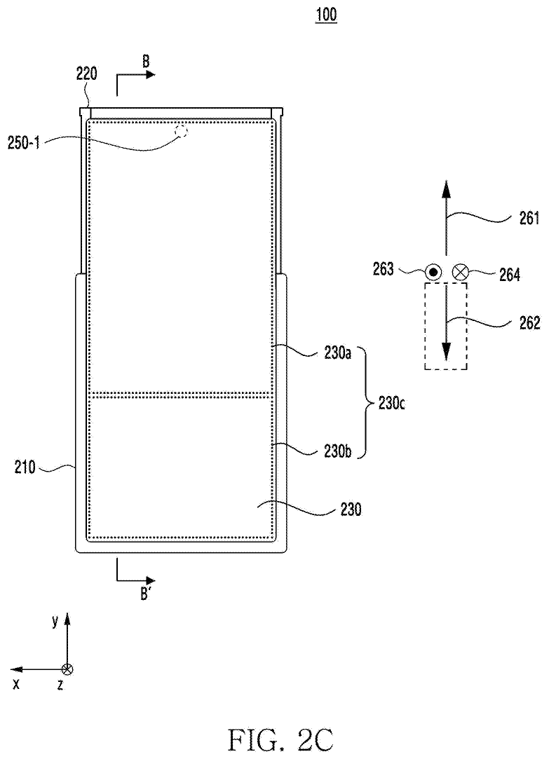

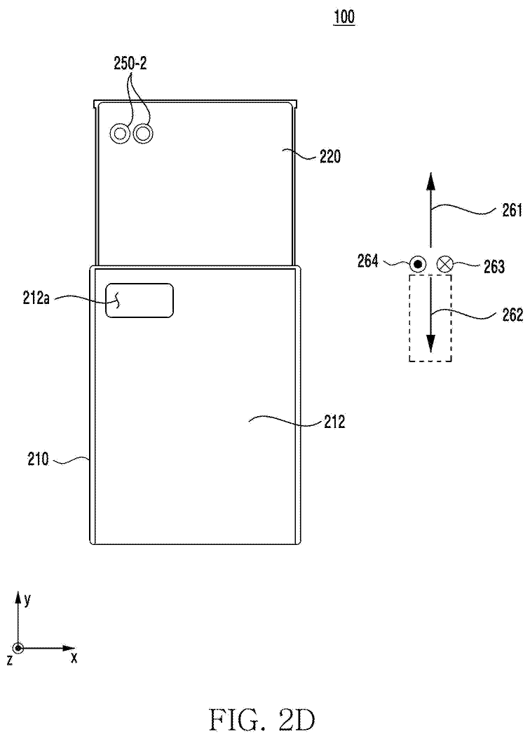

For example, the display 140 may provide at least a portion of an outer surface of the electronic device 100 and may include a display area visually exposed outside a housing of the electronic device 100. For example, since the display 140 has flexibility, at least a portion of the display 140 may be rollable into the housing or slidable into the housing. For example, a size of the display area may be changed according to a size of the at least a portion of the display 140 rolled into the housing or slid into the housing. For example, the electronic device 100 including the display 140 may be in a plurality of states including a first state providing the display area having a first size and a second state providing the display area having a second size different from the first size. For example, the first state may be exemplified through descriptions of FIGS. 2A and 2B.

FIG. 2A is a top plan view of an electronic device in a first state according to an embodiment of the disclosure.

Referring to FIG. 2A, an electronic device 100 may include a first housing 210 (e.g., the first housing part 110), a second housing 220 (e.g., the second housing part 120) movable with respect to the first housing 210 in a first direction 261 parallel to a y-axis or a second direction 262 parallel to the y-axis and opposite to the first direction 261, and a display 230 (e.g., the display 140 of FIG. 1). Hereinafter, it is described that the second housing 220 is moved with respect to the first housing 210, but it is merely exemplary. For example, the first housing 210 may be moved with respect to the second housing 220. For example, a size of a display area of the display 230 visually exposed outside a housing (e.g., the housing 130) of the electronic device 100 may be changed according to a change in a relative positional relationship between the first housing 210 and the second housing 220.

For example, in the first state, the second housing 220 may be movable with respect to the first housing 210 in the first direction 261 among the first direction 261 and the second direction 262. For example, in the first state, the second housing 220 may not be movable with respect to the first housing 210 in the second direction 262.

For example, in the first state, the display 230 may provide the display area having a smallest size. For example, in the first state, the display area may correspond to a first area 230a. For example, although not illustrated in FIG. 2A, in the first state, an area (e.g., a second area 230b of FIG. 2C) of the display 230 different from the first area 230a that is the display area may be disposed in the first housing 210. For example, in the first state, the second area 230b may be covered by the first housing 210. For example, in the first state, the second area 230b may be moved into the first housing 210. For example, at least a portion of the second area 230b may be rollable into the first housing 210. For example, in the first state, the first area 230a may include a planar portion. For example, in the first state, a portion of the second area 230b may include a curved portion. However, it is not limited thereto. For example, the first area 230a may include, in the first state, a curved portion extending from the planar portion.

For example, the first state may be referred to as a slide-in state in terms of at least a portion of the second housing 220 being located in the first housing 210 in accordance with the second housing 220 slid toward the first housing 210. For example, the first state may be referred to as a reduced state (or retracted state) in terms of providing the display area having the smallest size. However, it is not limited thereto.

For example, the second housing 220 may include a front camera 250-1 obtaining visual information through a portion of the first area 230a and facing a third direction 263 parallel to a z-axis. For example, although not illustrated in FIG. 2A, the second housing 220 may include one or more rear cameras (e.g., the rear cameras 250-2 of FIG. 2B) visually exposed through a portion of the second housing 220 and facing a fourth direction 264 parallel to the z-axis and opposite to the third direction 263. For example, the one or more rear cameras 250-2 may be exemplified through descriptions of FIG. 2B.

FIG. 2B is a bottom view of an electronic device in a first state according to an embodiment of the disclosure.

Referring to FIG. 2B, in the first state, the one or more rear cameras 250-2 disposed in the second housing 220 may be located within a structure disposed in the first housing 210 for the one or more rear cameras 250-2. For example, since the one or more rear cameras 250-2 are located within the structure in the first state, the one or more rear cameras 250-2 may be visually exposed through the structure in the first state. The one or more rear cameras 250-2 may obtain visual information through the structure. For example, the structure may be variously implemented. For example, the structure may be an opening or a notch. For example, the structure may be an opening 212a in a first plate 212 of the first housing 210 surrounding at least a portion of the second housing 220. However, it is not limited thereto.

Referring again to FIG. 1, the first state may be changed to the second state.

For example, the first state (or the second state) may be changed to the second state (or the first state) through one or more intermediate states between the first state and the second state.

For example, the first state (or the second state) may be changed to the second state (or the first state), based on a defined user input. For example, the first state (or the second state) may be changed to the second state (or the first state) in response to a user input to a physical button visually exposed through a portion of the first housing 210 or a portion of the second housing 220. A type of the user input is not limited thereto. For example, the user input may include a user input through a touch screen within a display area of the display 230 or a user input through a microphone of the electronic device 100. For example, a state of the electronic device 100 may be changed to the second state (or the first state) by an external force applied to the first housing 210 and/or the second housing 220.

The second state may be exemplified through descriptions of FIG. 2C and FIG. 2D.

FIG. 2C is a top plan view of an electronic device 100 in a second state according to an embodiment of the disclosure.

Referring to FIG. 2C, in the second state, the second housing 220 may be movable with respect to the first housing 210 in the second direction 262 among the first direction 261 and the second direction 262. For example, in the second state, the second housing 220 may not be movable with respect to the first housing 210 in the first direction 261.

For example, in the second state, the display 230 may provide the display area having a largest size. For example, in the second state, the display area may correspond to an area 230c including the first area 230a and the second area 230b. For example, the second area 230b included in the first housing 210 in the first state may be visually exposed in the second state. For example, in the second state, the first area 230a and the second area 230b may include a planar portion. However, it is not limited thereto. For example, the first area 230a and/or the second area 230b may include a curved portion extending from the planar portion and located in an edge portion.

For example, the second state may be referred to as a slide-out state in terms of at least a portion of the second housing 220 being located outside the first housing 210 according to the second housing 220 slid from the first housing 210. For example, the second state may be referred to as an extended state in terms of providing the display area having the largest size. However, it is not limited thereto.

For example, the front camera 250-1 facing the third direction 263 may be moved with the first area 230a according to movement of the second housing 220 in the first direction 261, when a state of the electronic device 100 is changed from the first state to the second state. For example, although not illustrated in FIG. 2C, one or more rear cameras (e.g., the rear cameras 250-2 of FIG. 2D) facing the fourth direction 264 may be moved with the second housing 220 according to movement of the second housing 220 in the first direction 261, when a state of the electronic device 100 is changed from the first state to the second state. For example, a relative positional relationship between the one or more rear cameras 250-2 and the structure exemplified through descriptions of FIG. 2B may be changed according to the movement of the one or more rear cameras 250-2. For example, the change of the relative positional relationship may be exemplified through FIG. 2D.

FIG. 2D is a bottom view of an electronic device 100 in a second state according to an embodiment of the disclosure.

Referring to FIG. 2D, in the second state, one or more rear cameras 250-2 may be located outside the structure. For example, in the second state, the one or more rear cameras 250-2 may be located outside an opening 212a within the first plate 212. For example, since the one or more rear cameras 250-2 are located outside the opening 212a in the second state, the one or more rear cameras 250-2 may be visually exposed in the second state. The one or more rear cameras 250-2 located outside the structure may obtain visual information. For example, since the one or more rear cameras 250-2 are located outside the structure in the second state, a relative positional relationship between the one or more rear cameras 250-2 and a structure (e.g., the opening 212a) in the second state may be different from the relative positional relationship between the one or more rear cameras 250-2 and a structure (e.g., the opening 212a) in the first state (e.g., in FIG. 2B).

Although not illustrated in FIGS. 2A, 2B, 2C, and 2D, the electronic device 100 may be in an intermediate state between the first state and the second state. For example, a size of the display area in the intermediate state may be larger than a size of the display area in the first state and smaller than a size of the display area in the second state. For example, the display area in the intermediate state may correspond to an area including the first area 230a and a portion of the second area 230b. For example, in the intermediate state, a portion of the second area 230b may be visually exposed, and another portion (or a remaining portion) of the second area 230b may be covered by the first housing 210 or may be moved into the first housing 210. However, it is not limited thereto.

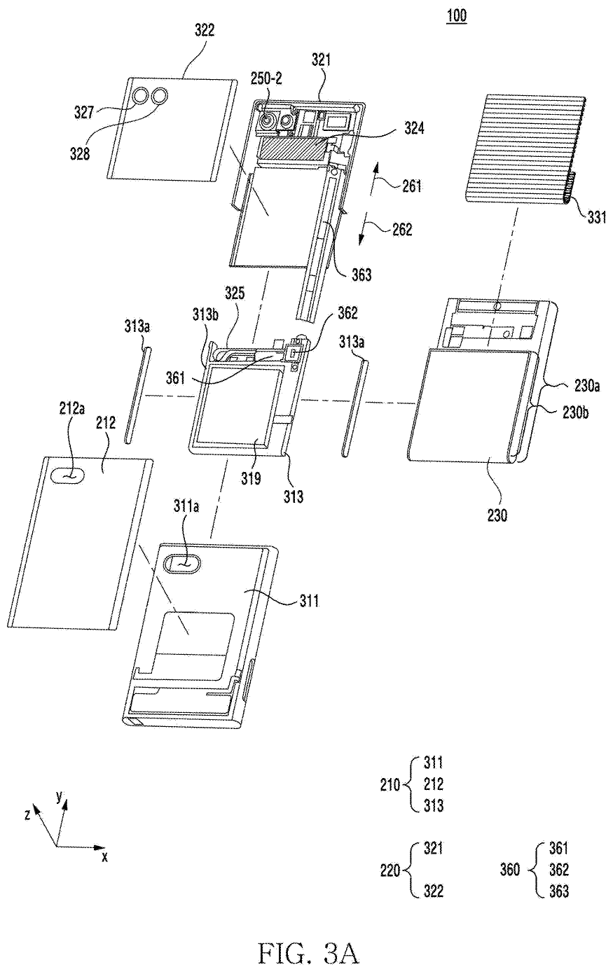

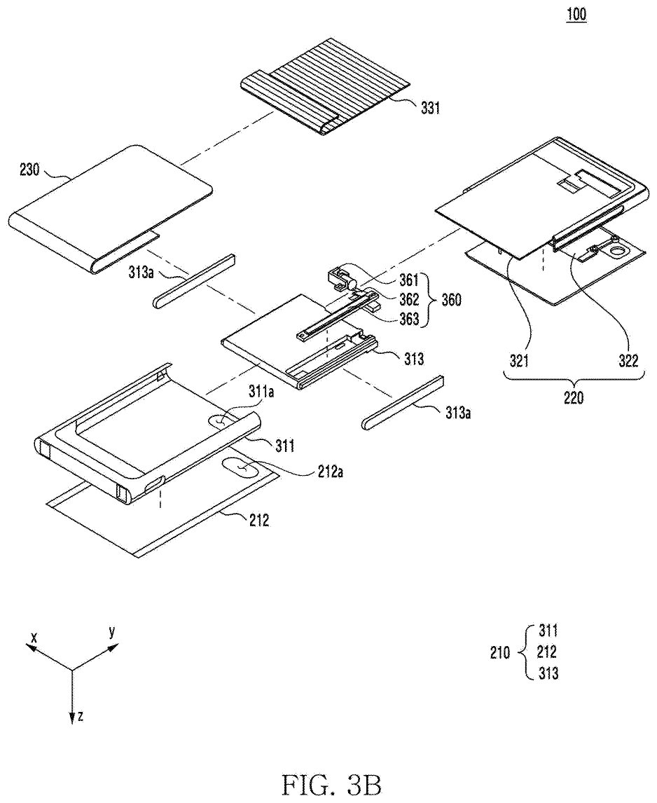

The electronic device 100 may include structures for moving a second housing (e.g., the second housing 220 of FIGS. 2A, 2B, 2C, and 2D) of the electronic device 100 with respect to a first housing (e.g., the first housing 210 of FIGS. 2A, 2B, 2C, and 2D) of the electronic device 100. For example, the structures may be exemplified through descriptions of FIGS. 3A and 3B.

FIGS. 3A and 3B are exploded perspective views of an electronic device according to various embodiments of the disclosure.

Referring to FIGS. 3A and 3B, an electronic device 100 may include a first housing 210, a second housing 220, a display 230, and a driving unit 360.

For example, the first housing 210 may include a first cover 311, a first plate 212, and a frame 313.

For example, the first cover 311 may at least partially form a side portion of an outer surface of the electronic device 100. For example, the first cover 311 may at least partially form a rear portion of the outer surface. For example, the first cover 311 may include an opening 311a for one or more rear cameras 250-2. For example, the first cover 311 may include a surface supporting the first plate 212. For example, the first cover 311 may be coupled to the first plate 212. For example, the first cover 311 may provide a space in which the frame 313 is seated. For example, the first cover 311 may be coupled to the frame 313.

For example, the first plate 212 may at least partially form a rear portion of the outer surface. For example, the first plate 212 may include an opening 212a for the one or more rear cameras 250-2. For example, the first plate 212 may be disposed on the surface of the first cover 311. For example, the opening 212a may be aligned with the opening 311a.

For example, the frame 313 may be at least partially surrounded by the first cover 311.

For example, the frame 313 may be at least partially surrounded by the display 230. For example, the frame 313 may be at least partially surrounded by the display 230, but a position of the frame 313 may be maintained independently of movement of the display 230. For example, the frame 313 may be arranged with respect to at least a portion of components of the display 230. For example, the frame 313 may include rails 313a providing (or guiding) a path of movement of at least one component of the display 230.

For example, the frame 313 may be coupled to at least one component of the electronic device 100. For example, the frame 313 may support a rechargeable battery 319. For example, the battery 319 may be supported through a recess or a hole in a surface 313b of the frame 313. For example, the frame 313 may fix an end of a flexible printed circuit board (FPCB) 325 on a surface of the frame 313. An end of the FPCB 325 may be electrically connected to a motor 361. For example, although not explicitly illustrated in FIGS. 3A and 3B, another end of the FPCB 325 may be connected to the PCB 324 through at least one connector. For example, the PCB 324 may be electrically connected to another PCB (not illustrated in FIGS. 3A and 3B) supplying power to the motor 361 through the FPCB 325.

For example, the frame 313 may be coupled to at least one structure of the electronic device 100 for a plurality of states including the first state and the second state. For example, the frame 313 may fasten the motor 361 of the driving unit 360.

For example, the second housing 220 may be movably engaged with the first housing 210. The second housing 220 may include a second cover 321 and a second plate 322.

For example, the second cover 321 may be at least partially surrounded by the display 230. For example, the second cover 321 may be coupled to at least a portion of the first area 230a of the display 230 surrounding the second cover 321, unlike the frame 313, such that the display 230 is moved according to the second housing 220 moved with respect to the first housing 210.

For example, the second cover 321 may be coupled to at least one component of the electronic device 100. For example, the second cover 321 may be coupled to a printed circuit board (PCB) 324 including components of the electronic device 100. For example, the PCB 324 may include a processor (not illustrated in FIGS. 3A and 3B). For example, the second cover 321 may include one or more rear cameras 250-2.

For example, the second cover 321 may be coupled to at least one structure of the electronic device 100 for a plurality of states including the first state and the second state. For example, the second cover 321 may fasten a rack gear 363 of the driving unit 360.

For example, the motor 361 of the driving unit 360 may be fixed to the second cover 321, and the rack gear 363 of the driving unit 360 may be fixed to the frame 313.

For example, the second cover 321 may be coupled to the second plate 322.

For example, the second plate 322 may be coupled to the second cover 321 to protect at least one component of the electronic device 100 coupled in the second cover 321 and/or at least one structure of the electronic device 100 coupled in the second cover 321. For example, the second plate 322 may include a structure for the at least one component. For example, the second plate 322 may include one or more openings 327 and 328 for the one or more rear cameras 250-2. For example, the one or more openings 327 and 328 may be aligned with the one or more rear cameras 250-2 disposed on the second cover 321. For example, a size of each of the one or more openings 327 and 328 may correspond to a size of each of the one or more rear cameras 250-2.

For example, the display 230 may include a support member 331. For example, the support member 331 may include a plurality of bars. For example, the plurality of bars may be coupled to each other. The support member 331 may support the second area 230b of the display 230.

For example, the driving unit 360 may include the motor 361, the pinion gear 362, and the rack gear 363.

For example, the motor 361 may operate based on power from the battery 319. For example, the power may be provided to the motor 361 in response to the defined user input.

For example, the pinion gear 362 may be coupled to the motor 361 through a shaft. For example, the pinion gear 362 may be rotated based on the operation of the motor 361 transmitted through the shaft.

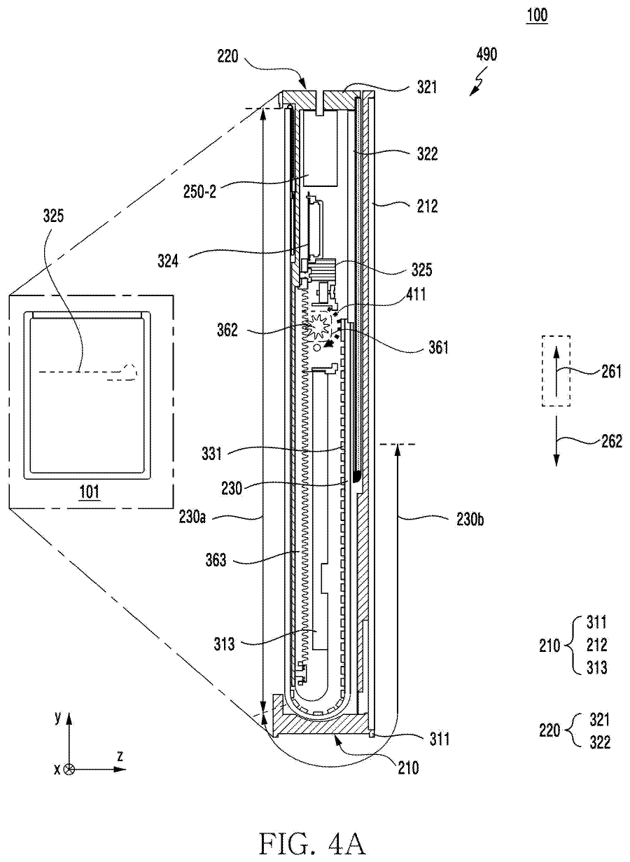

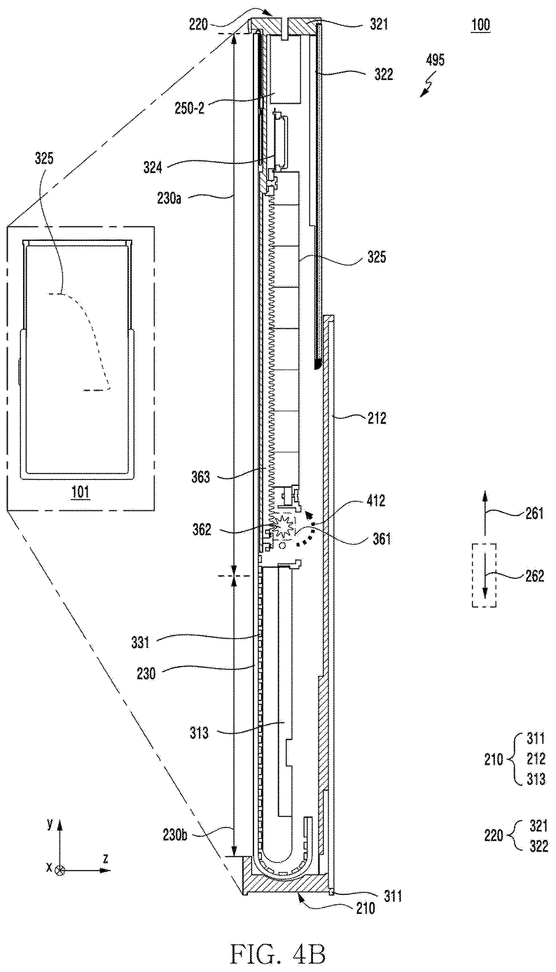

For example, the rack gear 363 may be arranged with respect to the pinion gear 362. For example, teeth of the rack gear 363 may be engaged with teeth of the pinion gear 362. For example, the rack gear 363 may be moved in the first direction 261 or the second direction 262, according to rotation of the pinion gear 362. For example, the second housing 220 may be moved in the first direction 261 and the second direction 262 by the rack gear 363 moved according to the rotation of the pinion gear 362 due to the operation of the motor 361. For example, the first state of the electronic device 100 may be changed to a state (e.g., the one or more intermediate states or the second state) different from the first state, through the movement of the second housing 220 in the first direction 261. For example, the second state of the electronic device 100 may be changed to a state (e.g., the one or more intermediate states or the first state) different from the second state, through the movement of the second housing 220 in the second direction 262. For example, the first state of the electronic device 100 being changed to the second state by the driving unit 360 and the second state of the electronic device 100 being changed to the first state by the driving unit 360 may be exemplified through FIGS. 4A and 4B.

FIG. 4A is a cross-sectional view of an electronic device in a first state according to an embodiment of the disclosure. FIG. 4B is a cross-sectional view of an electronic device in a second state according to an embodiment of the disclosure.

Referring to FIGS. 4A and 4B, the motor 361 may be operated based at least in part on the defined user input received in the first state 490. For example, the pinion gear 362 may be rotated in a first rotation direction 411, based at least in part on the operation of the motor 361. For example, the rack gear 363 may be moved in the first direction 261, based at least in part on the rotation of the pinion gear 362 in the first rotation direction 411. For example, since the second cover 321 in the second housing 220 fixes the rack gear 363, the second housing 220 may be moved in the first direction 261 based at least in part on the movement of the rack gear 363 in the first direction 261. For example, since the second cover 321 in the second housing 220 is coupled to at least a portion of the first area 230a of the display 230 and fixes the rack gear 363, the display 230 may be moved in the first direction 261 based at least in part on the movement of the rack gear 363 in the first direction 261. For example, the display 230 may be moved along the rails 313a of FIG. 3B. For example, as the support member 331 is moved in the first direction 261 along the rails 313a, the display 230 supported by the support member 331 may be moved in the first direction 261. For example, a shape of at least a portion of the plurality of bars of the support member 331 of the display 230 may be changed when the first state 490 is changed to the second state 495.

For example, the second area 230b of the display 230 may be moved according to the movement of the display 230. For example, the second area 230b may be moved through a space between the first cover 311 and the frame 313, when the first state 490 is changed to the second state 495 according to the defined user input. For example, the second area 230b in the second state 495 may be visually exposed, unlike the second area 230b rolled into the space in the first state 490.

For example, since the second cover 321 in the second housing 220 is coupled to the PCB 324 connected to the other end of the FPCB 325 and fixes the rack gear 363, a shape of the FPCB 325 may be changed when the first state 490 is changed to the second state 495.

The motor 361 may be operated based at least in part on the defined user input received in the second state 495. For example, the pinion gear 362 may be rotated in a second rotation direction 412 based at least in part on the operation of the motor 361. For example, the rack gear 363 may be moved in the second direction 262 based at least in part on the rotation of the pinion gear 362 in the second rotation direction 412. For example, since the second cover 321 in the second housing 220 fixes the rack gear 363, the second housing 220 may be moved in the second direction 262 based at least in part on the movement of the rack gear 363 in the second direction 262. For example, since the second cover 321 in the second housing 220 is coupled to at least a portion of the first area 230a of the display 230 and fixes the rack gear 363, the display 230 may be moved based at least in part on the movement of the rack gear 363 in the second direction 262. As the support member 331 is moved in the second direction 262 along the rails 313a, the display 230 supported by the support member 331 may be moved in the second direction 262. For example, the display 230 may be moved along rails (e.g., the rails 313a of FIG. 3B). For example, a shape of at least a portion of the plurality of bars of the support member 331 of the display 230 may be changed when the second state 495 is changed to the first state 490. The support member 331 may be moved with respect to the first housing 210. The support member 331 accommodated inside the first housing 210 in the first state 490 may be located between the first cover 311 and the frame 313. The display 230 may be moved with respect to the first housing 210 according to the movement of the support member 331.

For example, the second area 230b of the display 230 may be moved according to the movement of the display 230. For example, the second area 230b may be moved through a space between the first cover 311 and the frame 313 when the second state 495 is changed to the first state 490 according to the defined user input. For example, the second area 230b in the first state 490 may be rollable into the space, unlike the second area 230b visually exposed in the second state 495.

For example, since the second cover 321 in the second housing 220 is coupled to the PCB 324 connected to the other end of the FPCB 325 and fixes the rack gear 363, a shape of the FPCB 325 may be changed when the second state 495 is changed to the first state 490.

Although FIGS. 2A to 2D, 3A, 3B, 4A, and 4B illustrate the electronic device 100 in which a height of the display area is changed and a width of the display area is maintained when the first state (or the second state) is changed to the second state (or the first state) in a portrait mode, this is for convenience of description. For example, the electronic device 100 may be implemented such that a height of the display area is maintained and a width of the display area is changed when the first state (or the second state) is changed to the second state (or the first state) in the portrait mode.

Referring again to FIG. 1, the electronic device 100 may be in a state 180 corresponding to the first state 490 exemplified above. For example, the electronic device 100 may be in a state 190 corresponding to the second state 495 exemplified above. For example, a state of the electronic device 100 may be changed from the state 180 to the state 190. For example, the state of the electronic device 100 may be changed from the state 190 to the state 180.

For example, the electronic device 100 may display a screen in the state 180.

The screen may include a first portion 160 of information. For example, the information may include the first portion 160 of the information included in the screen and a second portion 165 of the information not included in the screen. For example, the second portion 165 of the information may be located below the first portion 160 of the information or located behind the first portion 160 of the information. For example, the second portion 165 of the information may be located outside the screen in the state 180. For example, the second portion 165 of the information may be included in the screen, based on (or in response to) a scroll input received in the state 180.

The screen may be displayed on an area 170. For example, the area 170 may be visible from the front side of the housing 130.

For example, the electronic device 100 may change a state of the electronic device 100 from the state 180 to the state 190, based on receiving an input. For example, the input may indicate extending the area 170. For example, the input may be received for a request to extend the area 170. For example, the input may be received to move the second housing part 120 with respect to the first housing part 110 to extend the area 170. For example, the input may be received to change the state 180 to the state 190.

For example, the electronic device 100 may display the screen in the state 190. For example, the electronic device 100 may extend the area 170, according to the second housing part 120 moved with respect to the first housing part 110 based on the input. For example, the area 170 in the state 190 may further include an area 175 than the area 170 in the state 180. As a non-limiting example, the area 175 in the state 180 may not be visible from the front side of the housing 130 due to being rolled into the first housing part 110, but the area 175 in the state 190 may be visible from the front side of the housing 130 due to the second housing part 120 moved with respect to the first housing part 110.

For example, the electronic device 100 may extend the screen displayed using the display 140, according to the change from the state 180 to the state 190 (or according to the input). For example, the electronic device 100 may extend the screen to fill (or occupy) the area 170 extended according to the input. For example, the extended screen displayed in the state 190 may further include the second portion 165 of the information than the screen displayed in the state 180. For example, the second portion 165 of the information located outside the screen in the state 180 may be included in the extended screen together with the first portion 160 of the information in the state 190.

As described above, the area 170 may be extended during the change from the state 180 to the state 190. The screen may be extended during the change from the state 180 to the state 190. Since the screen is extended while the area 170 is extended, synchronizing extending of the area 170 and extending of the screen may be required in the electronic device 100. For example, synchronizing a rate at which the area 170 is extended and a refresh rate for displaying the screen extended while the area 170 is extended may be required in the electronic device 100.

As a non-limiting example, when a rate at which the area 170 is extended during the change from the state 180 to the state 190 and a refresh rate for displaying the screen extended while the area 170 is extended are not synchronized, a quality of the screen extended on the area 170 extended during the change from the state 180 to the state 190 may be reduced. As a non-limiting example, as indicated by the state 195, during the change from the state 180 to the state 190, flickering (or stuttering) may occur in the screen.

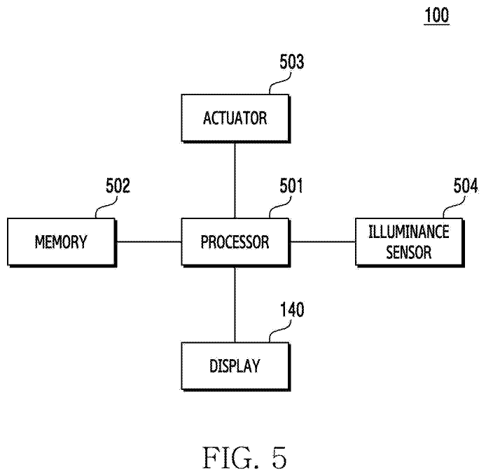

An electronic device 100 to be exemplified below may execute operations for synchronizing a rate at which the area 170 is extended and the refresh rate for displaying the screen extended while the area 170 is extended, during the change from the state 180 to the state 190, for a quality of the screen displayed using the display 140. For example, while the area 170 is extended, the electronic device 100 may synchronize a refresh rate of the screen according to the rate at which the area 170 is extended, by changing the refresh rate of the screen according to the rate at which the area 170 is extended. For example, the electronic device 100 may synchronize a refresh rate of the screen according to the rate at which the area 170 is extended, by controlling the rate at which the area 170 is extended according to the refresh rate of the screen. For example, the electronic device 100 may include components for executing (or performing) these operations. The components are exemplified in descriptions of FIG. 5.

FIG. 5 is a simplified block diagram of an electronic device according to an embodiment of the disclosure.

Referring to FIG. 5, an electronic device 100 may include a display 140, a processor 501, memory 502, an actuator 503, and an illuminance sensor 504.

The processor 501 may be used to execute (or perform) at least a portion of operations exemplified in the description of FIG. 1 and operations to be exemplified below. For example, the processor 501 may be configured to control the display 140, the actuator 503, and the illuminance sensor 504. For example, the processor 501 may be configured to execute instructions in the memory 502 for the controlling.

As a non-limiting example, the processor 501 may include processors. For example, a portion of the processors may be included in an application processor (AP). For example, another portion of the processors may be included in the memory 502, the actuator 503, the illuminance sensor 504, and/or the display 140.

The display 140 may be used to display visual information. For example, the visual information may be displayed on the area 170 (e.g., an area visible from the front side of the housing 130) exemplified in the description of FIG. 1. For example, the visual information may be displayed within (or in) the area 170. For example, the visual information may be provided from the processor 501. For example, the visual information may be obtained or generated by the processor 501 according to executing one or more software applications installed in the electronic device 100 and may be provided from the processor 501 to the display 140. However, it is not limited thereto. For example, the display 140 may include internal memory (e.g., graphic random access memory (GRAM)). For example, the display 140 may be configured to display, on (or in) the area 170, the visual information at least temporarily stored in the internal memory.

The memory 502 may store instructions for executing (or performing) at least a portion of operations exemplified in the description of FIG. 1 and operations to be exemplified below. For example, the instructions may be included in one or more programs (or one or more software applications). As a non-limiting example, a portion of the instructions may be provided from one or more software applications, and another portion of the instructions may be provided from an operating system. For example, at least a portion of the instructions may be stored in the memory 502 before the electronic device 100 is released. For example, at least a portion of the instructions may be stored in the memory 502 after the electronic device 100 is released. As a non-limiting example, at least a portion of the instructions may be stored in the memory 502 through a request (or an input) from a user (or an end user) using the electronic device 100.

As a non-limiting example, the memory 502 may include one or more memories respectively included in one or more components of the electronic device 100. For example, the memory 502 may include a volatile storage device (or a medium) of the electronic device 100 and a non-volatile storage device (or a medium) of the electronic device 100 as well as memory located in the actuator 503, memory located in the display 140 (e.g., the GRAM), memory located in the illuminance sensor 504, and/or memory located in the processor 501.

The actuator 503 may include at least a portion of the driving unit 360 exemplified in the descriptions of FIG. 3A, 3B, 4A, and 4B or may correspond to at least a portion of the driving unit 360 exemplified in the descriptions of FIGS. 3A, 3B, 4A, and 4B. For example, the actuator 503 may be used to move the second housing part 120 with respect to the first housing part 110 in accordance with controlling of the processor 501. For example, the actuator 503 may be configured to cause the change from the state 180 to the state 190 exemplified in the description of FIG. 1 in accordance with controlling of the processor 501. For example, the actuator 503 may be configured to cause a change from the state 190 to the state 180 in accordance with controlling of the processor 501. For example, the actuator 503 may be used to cause a change of a size of the area 170 visible from the front side of the housing 130.

The illuminance sensor 504 may be used to obtain data on illuminance (or brightness) around the electronic device 100. For example, the illuminance sensor 504 may be configured to obtain the data in accordance with controlling of the processor 501. For example, the illuminance sensor 504 may be configured to provide the data to the processor 501 in accordance with controlling of the processor 501. For example, the data provided to the processor 501 may be analyzed or processed or recognized or identified by the processor 501.

As illustrated in FIG. 5, the electronic device 100 including the illuminance sensor 504 is merely exemplary. According to embodiments, the electronic device 100 may not include the illuminance sensor 504.

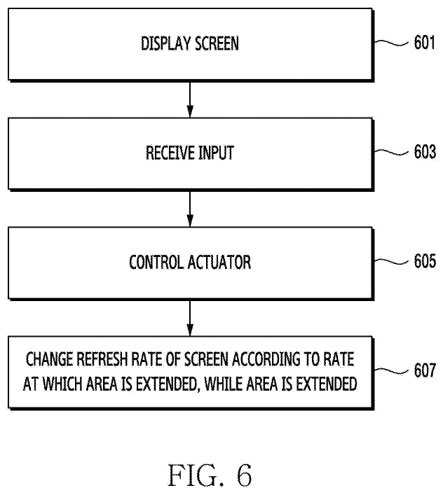

As described above, the electronic device 100 may execute operations for synchronizing a rate at which the area 170 is extended and the refresh rate for displaying the screen extended while the area 170 is extended during the change from the state 180 to the state 190 by using the above exemplified components (e.g., the display 140, the processor 501, the memory 502, the actuator 503, and the illuminance sensor 504). Operations of the electronic device 100 in descriptions of FIGS. 6, 7, 8A, 8B, 9 to 12, 13A, 13B, 14, and 15 may be caused according to the instructions in the memory 502 executed by the processor 501.

FIG. 6 is a flowchart illustrating a method for changing a refresh rate of a screen extended on an area to a rate at which the area is extended, while the area is extended according to an embodiment of the disclosure.

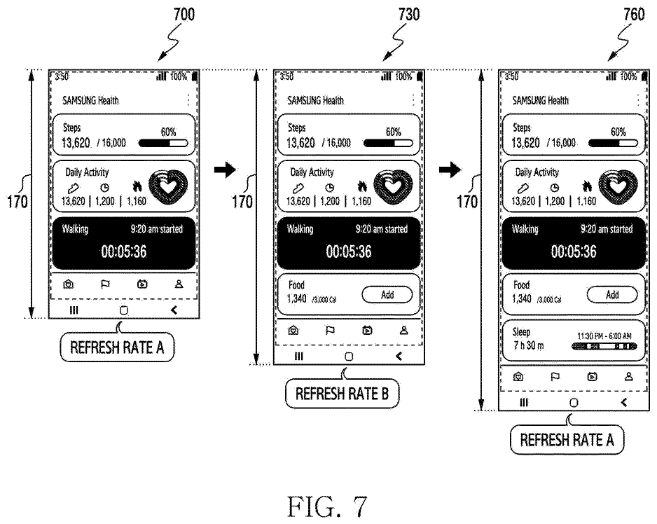

Referring to FIG. 6, in operation 601, the processor 501 may display a screen (e.g., the screen exemplified in the description of FIG. 1). For example, the screen may be displayed on an area (e.g., the area 170) visible from the front side of the housing 130. For example, the screen may be displayed in a state of the electronic device 100 in which the area is extendable. As a non-limiting example, the screen may be displayed in the state 180. As a non-limiting example, the screen may be displayed in the first state exemplified in the descriptions of FIGS. 2A to 2D, 3A, 3B, 4A, and 4B. For example, the screen may be displayed in a state of the electronic device 100 distinguished from the state 190. For example, the screen may be displayed in a state of the electronic device 100 distinguished from the second state exemplified in the descriptions of FIGS. 2A to 2D, 3A, 3B, 4A, and 4B. The display of the screen is exemplified in the description of FIG. 7.

FIG. 7 illustrates an example of a screen displayed with a refresh rate changed to a rate at which an area is extended, while the area is extended according to an embodiment of the disclosure.

Referring to FIG. 7, the processor 501 may display a screen by using the display 140, in a state 700. For example, the processor 501 may be configured to cause the display 140 displaying the screen, in the state 700. For example, the state 700 may correspond to a state 180 (or the first state exemplified in the description of FIGS. 2A to 2D, 3A, 3B, 4A, and 4B). For example, the state 700 may indicate a state of the electronic device 100 capable of extending the area 170 visible from the front side of the housing 130.

For example, in the state 700, the processor 501 may display the screen on the area 170 with a refresh rate a. As a non-limiting example, the processor 501 may display the screen with a refresh rate a determined according to a request from a software application providing the screen. As a non-limiting example, the processor 501 may display the screen with a refresh rate a determined according to a display setting (or a system setting) (or a global setting) of the electronic device 100. As a non-limiting example, a refresh rate a may correspond to a reference refresh rate among a plurality of reference refresh rates available for the display 140 (or in the electronic device 100) (or a plurality of reference refresh rates supported by the electronic device 100 (or the display 140). As a non-limiting example, each of the plurality of reference refresh rates may be a divisor of 240 hertz (Hz). For example, the plurality of reference refresh rates may include 1 Hz, 2 Hz, 3 Hz, 4 Hz, 5 Hz, 6 Hz, 8 Hz, 10 Hz, 12 Hz, 15 Hz, 16 Hz, 20 Hz, 24 Hz, 30 Hz, 40 Hz, 48 Hz, 60 Hz, 80 Hz, 120 Hz, and/or 240 Hz. As a non-limiting example, the plurality of reference refresh rates may include a multiple of a reference refresh rate. For example, the plurality of reference refresh rates may further include 96 Hz.

As a non-limiting example, the refresh rate a may be determined through “RefreshRate Manager” that is a system process (or a service) (or a system service) stored in the memory 502. For example, the refresh rate a determined through “RefreshRate Manager” may be provided to “SurfaceFlinger” that is a system process (or a service) (or a system service) stored in the memory 502.

Referring again to FIG. 6, in operation 603, the processor 501 may receive an input for extending the area while the screen is displayed on the area. For example, the input may correspond to the input exemplified in the description of FIG. 1 (e.g., an input causing the change from the state 180 to the state 190). As a non-limiting example, the input may include an input pressing a physical button exposed through a portion of the housing 130 of the electronic device 100. As a non-limiting example, the input may include a touch input to an executable object in the screen displayed on the area. As a non-limiting example, the input may include an external force from a user applied to the first housing part 110 and/or the second housing part 120 to move the second housing part 120 with respect to the first housing part 110. As a non-limiting example, the input may include a request, which is received from an external electronic device using a communication circuit (not illustrated in FIG. 5) of the electronic device 100, to extend the area.

For example, receiving the input may include recognizing (or identifying) (or confirming) the input. For example, receiving the input may include completing interpreting an intention of a user indicated through the input. For example, receiving the input may include determining a function to be executed in response to the input. However, it is not limited thereto.

Operation 603 of FIG. 6 is merely exemplary. For example, operation 603 may be replaced with the processor 501 detecting or identifying or recognizing or confirming an event causing changing the area (e.g., extending the area) while the screen is displayed on the area. For example, the event may indicate an event causing moving the second housing part 120 with respect to the first housing part 110 while the screen is displayed. As a non-limiting example, the event may include an event causing the electronic device 100 to move the second housing part 120 with respect to the first housing part 110 from an external electronic device (e.g., earbuds, a smartwatch, a server, or a video see through (VST) device). As a non-limiting example, the event may include receiving a message (e.g., a message for short message service (SMS)) from an external electronic device while a screen (e.g., a screen displayed in an always on display (AOD) mode (or state)) is displayed on the display 140 operating in a lower power state (or while the display 140 is in a power-off state). For example, the processor 501 may control the actuator 503 to move the second housing part 120 with respect to the first housing part 110 based on receiving the message to notify reception of the message.

In operation 605, the processor 501 may control the actuator 503 to move the second housing part 120 with respect to the first housing part 110 based on the input. For example, the processor 501 may control a power management integrated circuit (or circuitry) (PMIC) (not illustrated in FIG. 5) such that power for moving the second housing part 120 with respect to the first housing part 110 is provided to the actuator 503 in response to the input.

For example, referring to FIG. 7, the processor 501 may control the actuator 503 to change the state 700 to a state 760, in response to the input received in the state 700. The actuator 503 may cause the second housing part 120 moved with respect to the first housing part 110 such that the state 700 is changed to the state 760, according to the controlling of the processor 501. For example, the state 700 may be changed to the state 760 through a state 730, according to the second housing part 120 moved with respect to the first housing part 110 through the actuator 503.

Referring again to FIG. 6, in operation 607, the processor 501 may cause the display 140 changing a refresh rate of the screen extended on the area according to a rate at which the area is extended, while the area is extended as the second housing part 120 is moved with respect to the first housing part 110 in response to the input. For example, the refresh rate for displaying the screen extended as the area is extended may be changed according to the rate at which the area is extended. For example, the change of the refresh rate may be executed to reduce a probability that flickering occurs in the screen while the area is extended.

For example, referring to FIG. 7, the processor 501 may change the state 700 to the state 760 through the state 730, by controlling the actuator 503 in response to the input. For example, the processor 501 may determine a refresh rate for displaying the screen extended according to extension of the area 170 based on a rate at which the area 170 is extended, while the area 170 is extended.

For example, in the state 730, the processor 501 may display the screen extended on the area 170 extended for the change to the state 760 with a refresh rate b. As a non-limiting example, the refresh rate b may be determined through “RefreshRate Manager” that is a system process (or a service) (or a system service) stored in the memory 502. For example, “RefreshRate Manager” may obtain, from “Actuator Service” that is a system process (or a service) (or a system service) stored in the memory 502, data on a rate at which the area 170 is extended and may determine, as the refresh rate b, the refresh rate of the screen by using the obtained data. For example, the refresh rate b determined through “RefreshRate Manager” may be provided to “SurfaceFlinger” that is a system process (or a service) (or a system service) stored in the memory 502. As a non-limiting example, the data obtained from “Actuator Service” may be periodically provided to “RefreshRate Manager” regardless of whether the input (e.g., the input in operation 603) is received. As a non-limiting example, the data obtained from “Actuator Service” may be provided to “RefreshRate Manager” in response to the input. For example, the data obtained from “Actuator Service” may be provided to “RefreshRate Manager” on a condition that a change in the rate occurs.

For example, the refresh rate b may be different from the refresh rate a. As a non-limiting example, the refresh rate b may be determined according to a criterion at least partially distinguished from a criterion for determining the refresh rate a. For example, the refresh rate b may correspond to a rate at which the area 170 is extended. For example, the refresh rate b may be determined using a first parameter related to the rate at which the area 170 is extended (e.g., a rotation speed of a motor (e.g., the motor 361) in the actuator 503, a speed of a gear (e.g., the pinion gear 362 and/or the rack gear 363) in the actuator 503, and/or a movement distance of the second housing part 120). As a non-limiting example, the refresh rate b may be determined by further using (or further based on) a criterion used to determine the refresh rate a (e.g., the display setting, the request from the software application, and/or a type of content (or main content) provided through the screen extended while the area 170 is extended). For example, the refresh rate b may be determined using the first parameter and a second parameter for a criterion used to determine the refresh rate a. For example, a weight applied to the first parameter used to determine the refresh rate b may be higher than a weight applied to the second parameter used with the first parameter to determine the refresh rate b.

For example, various methods may be used to determine the refresh rate b in the state 730 used to display the screen extended on the area 170 extended for the change to the state 760. As a non-limiting example, the refresh rate b may be determined as a reference refresh rate corresponding to the rate at which the area 170 is extended, among the plurality of reference refresh rates. As a non-limiting example, the refresh rate b may be determined as a first reference refresh rate among the plurality of reference refresh rates when an instantaneous rate (or an average rate during a unit time) at which the area 170 is extended is k, and may be determined as a second reference refresh rate different from the first reference refresh rate among the plurality of reference refresh rates when an instantaneous rate (or an average rate during a unit time) at which the area 170 is extended is m.

Referring again to FIG. 6, the refresh rate used to display the screen may be changed according to the rate at which the area is extended, while the area is extended. As a non-limiting example, the electronic device 100 may include, in the memory 502, reference data indicating a relationship between the rate at which the area is extended and the refresh rate to change the refresh rate according to the rate at which the area is extended. As a non-limiting example, the reference data may be used while the area is extended. For example, the reference data may not be used after extending the area is completed (terminated). For example, the reference data may be indicated as shown in Table 1 below.

TABLE 1

| Rate (V) [symbol] | Refresh Rate [symbol] |
|---|---|
| 0 < V ≤ V1 [symbol] | R1 [symbol] |
| V1 < V ≤ V2 [symbol] | R2 [symbol] |
| (Omitted) [symbol] | (Omitted) [symbol] |
| Vn − 2 < V ≤ Vn − 1 [symbol] | Rn − 1 [symbol] |
| Vn − 1 < V ≤ Vn [symbol] | Rn [symbol] |

In Table 1, R1 to Rn may indicate at least a portion of the plurality of reference refresh rates, V may indicate an instantaneous rate (or an average rate during a unit time) at which the area is extended, V1 to Vn may indicate reference rates, Rn may indicate a highest reference refresh rate among R1 to Rn, and Vn may indicate a highest rate among V1 to Vn.

For example, the processor 501 may determine the refresh rate of the screen as Rn-1 by using the reference data indicated as in Table 1, when an instantaneous rate (or an average rate during a unit time) at which the area is extended is higher than Vn-2 and lower than Vn-1 at a first timing within a time interval in which the area is extended. For example, the processor 501 may determine the refresh rate of the screen as Rn by using the reference data indicated as in Table 1, when an instantaneous rate (or an average rate during a unit time) at which the area is extended is higher than Vn-1 and lower than Vn at a second timing (e.g., a timing after the first timing) within a time interval in which the area is extended. For example, the refresh rate of the screen may be changed from Rn-1 to Rn while the area is extended.

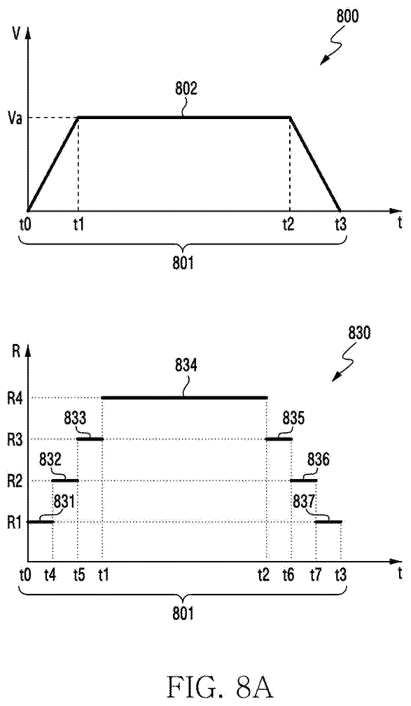

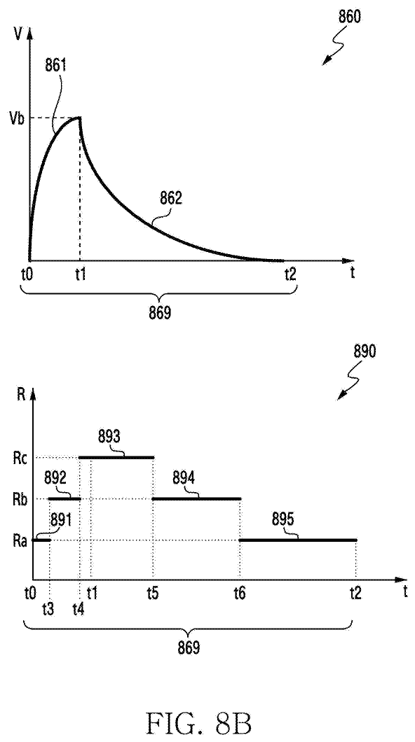

The change in the refresh rate is further exemplified in the description of FIGS. 8A and 8B.

FIGS. 8A and 8B illustrate an example of a refresh rate changed to a rate at which an area is extended according to various embodiments of the disclosure.

Referring to FIG. 8A, a chart 800 indicates a change in the rate at which the area is extended. A horizontal axis t of the chart 800 indicates time, and a vertical axis V of the chart 800 indicates a rate at which the area is extended. As a non-limiting example, the processor 501 may control the actuator 503 such that the area is extended during a time interval 801 (e.g., a time interval from a timing t0 to a timing t3), in response to the input (e.g., the input in operation 603). For example, the processor 501 may control the actuator 503 within the time interval 801 as the area being indicated by a line 802 in the chart 800. For example, the rate at which the area is extended may be changed from 0 to Va within a time interval from the timing t0 to the timing t1, maintained at Va within a time interval from the timing t1 to the timing t2, and changed from Va to 0 within a time interval from the timing t2 to the timing t3, as in the line 802 in the chart 800.

As a non-limiting example, the processor 501 may change the refresh rate of the screen as indicated by a chart 830, on a condition that the rate at which the area is extended is changed as in the line 802 in the chart 800. The chart 830 indicates a change in the refresh rate of the screen while the area is extended. A horizontal axis t of the chart 830 indicates time, and a unit of the horizontal axis t of the chart 830 is the same as a unit of the horizontal axis t of the chart 800. A vertical axis R of the chart 830 indicates the refresh rate of the screen. The timing to, the timing t1, the timing t2, and the timing t3 in the chart 830 are respectively the same as the timing to, the timing t1, the timing t2, and the timing t3 in the chart 800.

For example, the processor 501 may determine the refresh rate of the screen as R1 within a time interval from the timing t0 to the timing t4, as indicated by a line 831 in the chart 830. For example, the processor 501 may determine the refresh rate of the screen as R2 within a time interval from the timing t4 to a timing t5, as indicated by a line 832 in the chart 830. For example, the processor 501 may determine the refresh rate of the screen as R3 within a time interval from the timing t5 to the timing t1, as indicated by a line 833 in the chart 830. For example, the processor 501 may determine the refresh rate of the screen as R4 within a time interval from the timing t1 to the timing t2, as indicated by a line 834 in the chart 830. For example, the processor 501 may determine the refresh rate of the screen as R3 within a time interval from the timing t2 to a timing t6, as indicated by a line 835 in the chart 830. For example, the processor 501 may determine the refresh rate of the screen as R2 within a time interval from the timing t6 to a timing t7, as indicated by a line 836 in the chart 830. For example, the processor 501 may determine the refresh rate of the screen as R1 within a time interval from the timing t7 to the timing t3, as indicated by a line 837 in the chart 830. As a non-limiting example, R1 may be the same as a refresh rate of the screen before the area is extended (e.g., the refresh rate a in the state 700). As a non-limiting example, R1 may be the same as a refresh rate of the screen after (or immediately after) extending the area is completed (e.g., the refresh rate a in the state 760). As a non-limiting example, R1 to R4 may be at least a portion of the plurality of reference refresh rates.

The processor 501 may control the actuator 503 such that the second housing part 120 is non-linearly moved with respect to the first housing part 110, unlike the example of FIG. 8A. As a non-limiting example, the processor 501 may control the actuator 503 to reduce a probability that the electronic device 100 is damaged due to the second housing part 120 moved with respect to the first housing part 110. As a non-limiting example, the processor 501 may control the actuator 503 to provide an enhanced user experience in association with the second housing part 120 moved with respect to the first housing part 110. The controlling of the actuator 503 is exemplified in the description of FIG. 8B.

Referring to FIG. 8B, a chart 860 indicates a change in the rate at which the area is extended. A horizontal axis t of the chart 860 indicates time, and a vertical axis V of the chart 860 indicates a rate at which the area is extended. As a non-limiting example, the processor 501 may control the actuator 503 such that the area is extended during a time interval 869 (e.g., a time interval from the timing t0 to the timing t2), in response to the input (e.g., the input in operation 603). For example, the processor 501 may control the actuator 503 within the time interval 869 as the area being indicated by a curve 861 and a curve 862 in the chart 860. For example, a rate at which the area is extended may be non-linearly changed from 0 to Vb within a time interval from the timing t0 to the timing t1 and non-linearly changed from Vb to 0 within a time interval from the timing t1 to the timing t2, as in the curve 861 in the chart 860.

As a non-limiting example, the processor 501 may change the refresh rate of the screen as indicated by a chart 890 on a condition that the rate at which the area is extended is changed as in the curve 861 and the curve 862 in the chart 860. The chart 890 indicates a change in the refresh rate of the screen while the area is extended. A horizontal axis t of the chart 890 indicates time, and a unit of the horizontal axis t of the chart 890 is the same as a unit of the horizontal axis t of the chart 800. A vertical axis R of the chart 890 indicates the refresh rate of the screen. The timing to, the timing t1, and the timing t2 in the chart 890 are respectively the same as the timing to, the timing t1, and the timing t2 in the chart 860.

For example, the processor 501 may determine the refresh rate of the screen as Ra within a time interval from the timing t0 to a timing t3 as indicated by a line 891 in the chart 890. For example, the processor 501 may determine the refresh rate of the screen as Rb within a time interval from the timing t3 to a timing t4, as indicated by a line 892 in the chart 890. For example, the processor 501 may determine the refresh rate of the screen as Rc within a time interval from the timing t4 to a timing t5, as indicated by a line 893 in the chart 890. For example, the processor 501 may determine the refresh rate of the screen as Rb within a time interval from the timing t5 to a timing t6, as indicated by a line 894 in the chart 890. For example, the processor 501 may determine the refresh rate of the screen as Ra within a time interval from the timing t6 to the timing t2, as indicated by a line 895 in the chart 890. As a non-limiting example, Ra may be the same as a refresh rate of the screen before the area is extended (e.g., the refresh rate a in the state 700). As a non-limiting example, Ra may be the same as a refresh rate of the screen after (or immediately after) extending the area is completed (e.g., the refresh rate a in the state 760). As a non-limiting example, Ra, Rb, and Rc may be at least a portion of the plurality of reference refresh rates.

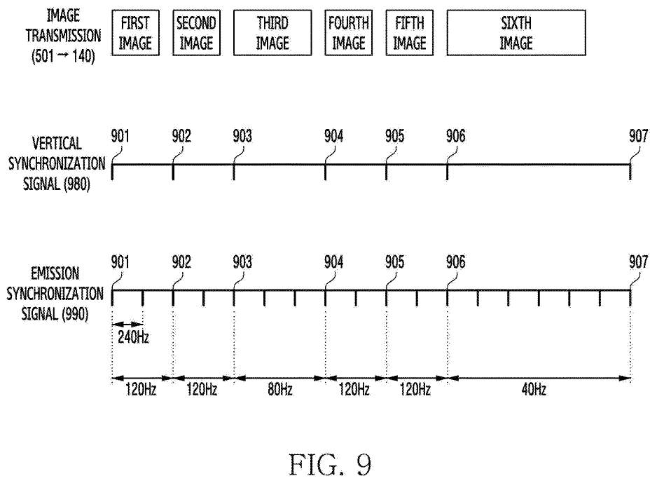

Referring again to FIG. 6, as a non-limiting example, the processor 501 may change a timing of transmitting, to the display 140, an image (e.g., a frame image) for displaying the screen according to a rate at which the area is extended to cause the display 140 to change the refresh rate of the screen extended on the area, according to the rate at which the area is extended while the area is extended. For example, the processor 501 may change the timing, by setting a second time interval between a start timing of transmission of a second image (an image after the first image) to the display 140 and a start timing of transmission of a third image (an image after the second image) to the display 140 shorter than a first time interval between a start timing of transmission of a first image for displaying the screen to the display 140 and the start timing of transmission of the second image to the display 140. The change of the timing is exemplified in the description of FIG. 9.

FIG. 9 illustrates a method for changing a refresh rate according to an embodiment of the disclosure.

Referring to FIG. 9, as a non-limiting example, an emission synchronization signal 990 may be a signal indicating a timing of starting emitting each of light-emitting elements (e.g., organic light emitting diodes (OLEDs) or micro LEDs) of the display 140. As a non-limiting example, the emission synchronization signal 990 may be a signal indicating a timing of an emission signal provided to each of driving transistors in a display panel in the display 140 for displaying a screen. As a non-limiting example, a frequency of the emission synchronization signal 990 may be 240 Hz. As a non-limiting example, a period of the emission synchronization signal 990 may be 1/240 second(s). As a non-limiting example, transmission of an image from the processor 501 to the display 140 may be allowed (or enabled) at each start timing of the emission synchronization signal 990.

For example, the processor 501 may transmit a first image for the displaying of the screen to the display 140 at a start timing 901 of the emission synchronization signal 990 while the area is extended. For example, a start timing of a vertical synchronization signal 980 for displaying the first image may be set to the start timing 901 of the emission synchronization signal 990 according to the transmission of the first image.

For example, the processor 501 may determine the refresh rate of the screen as 120 Hz based on checking that the rate at which the area is extended is within a first reference range, while the area is extended. For example, the processor 501 may transmit, to the display 140, a second image after the first image at a start timing 902 of the emission synchronization signal 990 corresponding to the refresh rate determined as 120 Hz, while the area is extended. As a non-limiting example, a content in the second image may be the same as a content in the first image. For example, the first image and the second image may be the same image. For example, a start timing of the vertical synchronization signal 980 for displaying the second image may be set to the start timing 902 of the emission synchronization signal 990.

For example, the processor 501 may determine the refresh rate of the screen as 120 Hz, based on checking that the rate at which the area is extended is within the first reference range, while the area is extended. For example, the processor 501 may transmit a third image after the second image to the display 140 at a start timing 903 of the emission synchronization signal 990 corresponding to the refresh rate determined as 120 Hz, while the area is extended. As a non-limiting example, a content in the third image may be the same as a content in the second image. For example, the second image and the third image may be the same image. For example, a start timing of the vertical synchronization signal 980 for displaying the third image may be set to the start timing 903 of the emission synchronization signal 990.

For example, the processor 501 may determine the refresh rate of the screen as 80 Hz, based on checking that the rate at which the area is extended is within a second reference range different from the first reference range (e.g., the second reference range includes values smaller than a minimum value in the first reference range) while the area is extended. For example, the processor 501 may transmit a fourth image after the third image to the display 140 at a start timing 904 of the emission synchronization signal 990 corresponding to the refresh rate determined as 80 Hz, while the area is extended. As a non-limiting example, a content in the fourth image may be the same as a content in the third image. For example, the third image and the fourth image may be the same image. For example, a start timing of the vertical synchronization signal 980 for displaying the fourth image may be set to the start timing 904 of the emission synchronization signal 990.

For example, the processor 501 may determine the refresh rate of the screen as 120 Hz based on checking that the rate at which the area is extended is within the first reference range, while the area is extended. For example, the processor 501 may transmit a fifth image after the fourth image to the display 140 at a start timing 905 of the emission synchronization signal 990 corresponding to the refresh rate determined as 120 Hz, while the area is extended. As a non-limiting example, a content in the fifth image may be the same as a content in the fourth image. For example, the fourth image and the fifth image may be the same image. For example, a start timing of the vertical synchronization signal 980 for displaying the fifth image may be set to the start timing 905 of the emission synchronization signal 990.

For example, the processor 501 may determine the refresh rate of the screen as 120 Hz based on checking that the rate at which the area is extended is within the first reference range while the area is extended. For example, the processor 501 may transmit a sixth image after the fifth image to the display 140 at a start timing 906 of the emission synchronization signal 990 corresponding to the refresh rate determined as 120 Hz, while the area is extended. As a non-limiting example, a content in the sixth image may be the same as a content in the fifth image. For example, the fifth image and the sixth image may be the same image. For example, a start timing of the vertical synchronization signal 980 for displaying the sixth image may be set to the start timing 906 of the emission synchronization signal 990.

For example, the processor 501 may determine the refresh rate of the screen as 40 Hz based on checking that the rate at which the area is extended is within a third reference range different from the first reference range and the second reference range (e.g., the third reference range includes values smaller than a minimum value in the second reference range) while the area is extended. For example, the processor 501 may transmit a seventh image (not illustrated) after the sixth image to the display 140 at a start timing 907 of the emission synchronization signal 990 corresponding to the refresh rate determined as 40 Hz while the area is extended. As a non-limiting example, a content in the seventh image may be the same as a content in the sixth image. For example, the sixth image and the seventh image may be the same image. For example, a start timing of the vertical synchronization signal 980 for displaying the seventh image may be set to the start timing 907 of the emission synchronization signal 990.

Referring again to FIG. 6, the electronic device 100 may reduce power consumed for displaying the screen while the area is extended, by determining the refresh rate of the screen in which the area is extended to correspond to the rate at which the area is extended. As a non-limiting example, a refresh rate used for displaying the screen while the area is extended may be higher as a rate at which the area is extended is higher. For example, the refresh rate of the screen when the rate at which the area is extended is a first rate may be higher than the refresh rate of the screen when the rate at which the area is extended is a second rate lower than the first rate.

As a non-limiting example, the rate at which the area is extended may be predefined or predetermined or preset in the electronic device 100. For example, when the rate at which the area is extended is predefined, data for the refresh rate changed according to the rate at which the area is extended may be stored in the memory 502 in advance.

As a non-limiting example, the rate at which the area is extended may be measured using a component of the electronic device 100, while the area is extended. For example, the processor 501 may determine the refresh rate of the screen displayed (or extended) on the area while the area is extended according to a result of the measurement and may display the screen with the determined refresh rate. For example, the electronic device 100 may include a hall sensor integrated circuit (or circuitry) (IC) configured to obtain data regarding a distance by which the second housing part 120 is moved with respect to the first housing part 110 (or data regarding a relative positional relationship between the first housing part 110 and the second housing part 120). For example, the processor 501 may measure the rate at which the area is extended, by using the data obtained through the hall sensor IC. As another example, the electronic device 100 may include a motor encoder in the actuator 503. For example, the processor 501 may measure the rate at which the area is extended, by using data obtained through the motor encoder. As still another example, the processor 501 may measure the rate at which the area is extended using a change in capacitance caused in the display 140 by using a touch circuit included in the display 140 to receive (or recognize) a touch input. However, it is not limited thereto.

As a non-limiting example, the processor 501 may restore the refresh rate of the screen to a refresh rate used before the input is received, in response to completion (or termination) of extending the area based on the input (the input in operation 603).

For example, referring to FIG. 7, the processor 501 may display the screen with a refresh rate a that is a refresh rate used to display the screen on the area 170 in the state 700, in a state 760 changed from the state 700 through the state 730. However, it is not limited thereto. For example, when a change in an environment around the electronic device 100 and/or a change in an execution state of the electronic device 100 occurs while the state 700 is changed to the state 760 through the state 730, the processor 501 may display the screen with another refresh rate different from the refresh rate a in the state 760.

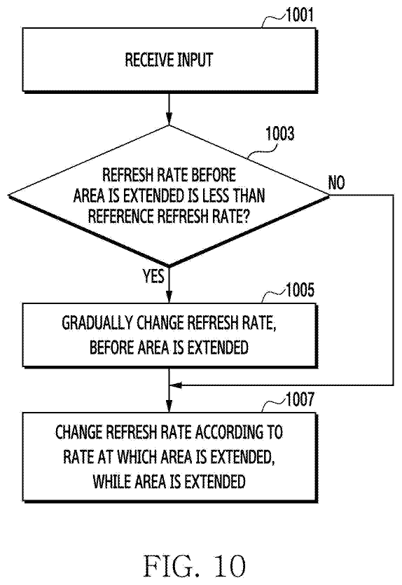

Referring again to FIG. 6, a rapid change in the refresh rate may cause flickering in the screen displayed on the area of the display 140. As a non-limiting example, when the refresh rate for displaying the screen is directly changed from 1 Hz to 120 Hz, flickering may be caused in the screen. For example, the processor 501 may check or determine or identify whether the refresh rate of the screen before the area is extended is less than a reference refresh rate to reduce a probability that such flickering occurs. This operation is exemplified in the description of FIG. 10.

FIG. 10 is a flowchart illustrating a method for gradually changing a refresh rate lower than a reference refresh rate before an area is extended according to an embodiment of the disclosure.

Referring to FIG. 10, in operation 1001, the processor 501 may receive an input. For example, operation 1001 may correspond to operation 603 of FIG. 6.

In operation 1003, the processor 501 may check or determine or identify whether a refresh rate before the area is extended is less than a reference refresh rate. As a non-limiting example, as indicated by the curve 861 in the chart 860 of FIG. 8B, the rate at which the area is extended may be rapidly increased in response to the input. For example, when the rate at which the area is extended is rapidly increased and the refresh rate before the area is extended is relatively low, changing the refresh rate of the screen according to the rate at which the area is extended may cause flickering. For example, the processor 501 may determine whether the refresh rate before the area is extended is less than the reference refresh rate to reduce a probability that the flickering occurs.

For example, the processor 501 may execute operation 1005 based on the refresh rate less than the reference refresh rate and may execute operation 1007 based on the refresh rate greater than or equal to the reference refresh rate.

In operation 1005, the processor 501 may gradually change the refresh rate of the screen before the area is extended in response to the input, on a condition that the refresh rate before (or immediately before) the area is extended is less than the reference refresh rate. For example, in a case that the refresh rate of the screen when the input is received in operation 1001 is 10 Hz, the refresh rate of the screen corresponding to a rate at which the area is extended in response to the input is 120 Hz, and the reference refresh rate is 60 Hz, the processor 501 may change the refresh rate of the screen displayed on the area from 10 Hz to 30 Hz before extending the area in response to the input, change the refresh rate of the screen displayed on the area from 30 Hz to 60 Hz before extending the area in response to the input, and change the refresh rate of the screen displayed on the area from 60 Hz to 96 Hz before extending the area in response to the input.

In operation 1007, the processor 501 may change the refresh rate of the screen extended on the area according to the rate at which the area is extended while the area is extended, based on completion of execution of operation 1005 or based on identifying that the refresh rate is greater than or equal to the reference refresh rate. For example, when operation 1007 is executed according to the completion of the execution of operation 1005, the processor 501 may change the refresh rate of the screen from 96 Hz to 120 Hz in response to starting extending the area. For example, the processor 501 may change the refresh rate of the screen according to the rate at which the area is extended while the area is extended after changing the refresh rate of the screen to 120 Hz.

As described above, the refresh rate of the screen being changed according to the rate at which the area is extended while the area is extended is merely exemplary.

Alternatively, the processor 501 may maintain the refresh rate of the screen regardless of the rate at which the area is extended (or independently of the rate at which the area is extended) in at least a portion of a time interval in which the area is extended. For example, the refresh rate of the screen maintained in the at least a portion of the time interval may be higher than the refresh rate of the screen before the input (e.g., the input in operation 603) is received. For example, the refresh rate of the screen maintained in the at least a portion of the time interval may be predetermined. For example, the refresh rate of the screen maintained in the at least a portion of the time interval may be a highest refresh rate supported in the electronic device 100. For example, the refresh rate of the screen maintained in the at least a portion of the time interval may be referred to as a predetermined refresh rate.

As a non-limiting example, the processor 501 may compare a refresh rate of the screen when receiving the input with the predetermined refresh rate, in response to receiving the input as in operation 1001. For example, the processor 501 may change the refresh rate of the screen when receiving the input to the predetermined refresh rate through one or more intermediate refresh rates, based on checking that a difference value between the refresh rate of the screen when receiving the input and the predetermined refresh rate exceeds a threshold value. For example, on a condition that the difference value exceeds the threshold value, the processor 501 may change a first refresh rate of the screen when receiving the input to a second refresh rate lower than the predetermined refresh rate in response to receiving the input and may change the second refresh rate to the predetermined refresh rate after displaying the screen with the second refresh rate. As a non-limiting example, the change from the first refresh rate to the second refresh rate and/or the change from the second refresh rate to the predetermined refresh rate may be executed before the area is extended in response to the input.

Referring again to FIG. 6, the refresh rate of the screen extended on the area while the area is changed may be determined based on not only the rate at which the area is extended but also another parameter.

As a non-limiting example, the processor 501 may cause the display 140 to change the refresh rate of the screen according to a type of a software application providing contents (or the screen) in the screen and a rate at which the area is extended, while the area is extended. For example, when the software application is a first software application and the rate at which the area is extended is w, the processor 501 may determine the refresh rate of the screen as e. For example, when the software application is a second software application and the rate at which the area is extended is w, the processor 501 may determine the refresh rate of the screen as y.

As a non-limiting example, the processor 501 may cause the display 140 to change the refresh rate of the screen according to a type of a main content in the screen and the rate at which the area is extended, while the area is extended. For example, when the main content is a static content and the rate at which the area is extended is w, the processor 501 may determine the refresh rate of the screen as e. For example, when the main content is a dynamic content and the rate at which the area is extended is w, the processor 501 may determine the refresh rate of the screen as y lower than e.

As a non-limiting example, the processor 501 may cause the display 140 to change the refresh rate of the screen according to a brightness level of the screen (or a brightness level of a display setting for displaying the screen) (or an overall brightness level of the screen) and a rate at which the area is extended, while the area is extended. For example, when the brightness level is a first brightness level and the rate at which the area is extended is w, the processor 501 may determine the refresh rate of the screen as e. For example, when the brightness level is a second brightness level and the rate at which the area is extended is w, the processor 501 may determine the refresh rate of the screen as y.

As a non-limiting example, the processor 501 may cause the display 140 to change the refresh rate of the screen according to a size of the area and the rate at which the area is extended, while the area is extended. As a non-limiting example, since a size of the screen increases as a size of the area increases, a time of scanning executed in the display 140 for displaying the screen may increase as the area is extended. The processor 501 may cause the display 140 to change the refresh rate of the screen according to a size of the area and a rate at which the area is extended, while the area is extended, to reduce flickering occurring according to the increase in the time of scanning. For example, when the size of the area being extended is a first size and the rate at which the area is extended is w, the processor 501 may determine the refresh rate of the screen as e. For example, when the size of the area being extended is a second size larger than the first size and the rate at which the area is extended is w, the processor 501 may determine the refresh rate of the screen as y higher than e.

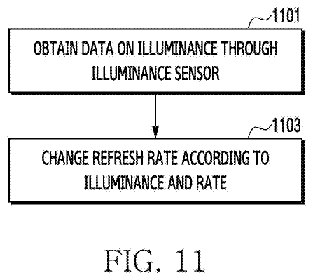

As a non-limiting example, the processor 501 may use illuminance around the electronic device 100 to determine the refresh rate of the screen while the area is extended. This operation is exemplified in the description of FIG. 11.

FIG. 11 is a flowchart illustrating a method for changing a refresh rate of a screen extended on an area to a rate at which the area is extended and an illuminance around an electronic device, while the area is extended according to an embodiment of the disclosure.

Referring to FIG. 11, in operation 1101, the processor 501 may obtain data on illuminance (or brightness) around the electronic device 100 through the illuminance sensor 504. As a non-limiting example, the processor 501 may obtain the data to change a brightness level provided through the display 140. As a non-limiting example, the processor 501 may obtain the data to determine whether an external object is located around the electronic device 100. As a non-limiting example, the processor 501 may obtain the data to determine whether a touch input received through the display 140 is an input intended by a user.

In operation 1103, the processor 501 may change the refresh rate of the screen according to the illuminance and the rate at which the area is extended, while the area is extended.

As a non-limiting example, since a probability that flickering that may occur when the rate at which the area is extended and the refresh rate of the screen extended while the area is extended are not synchronized is visible to a user may vary according to the illuminance, the processor 501 may change the refresh rate of the screen further based on the illuminance while the area is extended. For example, when the illuminance is a first value and the rate at which the area is extended is w, the processor 501 may determine the refresh rate of the screen as e. For example, when the illuminance is a second value and the rate at which the area is extended is w, the processor 501 may determine the refresh rate of the screen as y.

As described above, the refresh rate of the screen extended (or displayed) on the area while the area is extended may alternatively be maintained as a predetermined refresh rate regardless of the rate at which the area is extended in at least a portion of the time interval. For example, the processor 501 may use another predetermined refresh rate as the refresh rate of the screen, instead of the predetermined refresh rate, according to the illuminance. For example, when the illuminance is the first value, the processor 501 may determine the refresh rate of the screen as the predetermined refresh rate in the at least a portion of the time interval. For example, when the illuminance is the second value, the processor 501 may determine the refresh rate of the screen as the other predetermined refresh rate in the at least a portion of the time interval.

As a non-limiting example, the electronic device 100 may include one or more components (e.g., an optical sensor facing a direction toward which the display 140 faces) for determining (or identifying) (or checking) (or monitoring) whether a user is looking at the display 140. For example, the processor 501 may obtain data using the optical sensor.

For example, the processor 501 may change the refresh rate of the screen displayed on the area using at least a portion of operations exemplified in the description of FIGS. 6, 7, 8A, 8B, and 9 to 11, based on obtaining the data indicating that the user is looking at the display 140.

For example, the processor 501 may maintain the refresh rate of the screen displayed on the area as the refresh rate of the screen before the area is extended, while the area is extended, based on obtaining the data indicating that the user is not looking at the display 140. As another example, the processor 501 may change the refresh rate of the screen displayed on the area to a refresh rate lower than the refresh rate of the screen before the area is extended, while the area is extended, based on obtaining the data indicating that the user is not looking at the display 140.

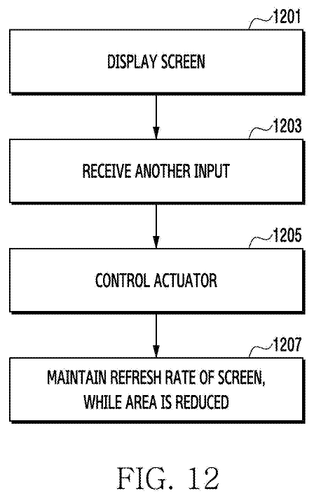

As exemplified in the description of FIGS. 6, 7, 8A, 8B, and 9 to 11, the processor 501 may change the refresh rate of the screen extended on the area while the area is extended, in response to an input causing extending the area (e.g., the input in operation 603). As a non-limiting example, the processor 501 may maintain the refresh rate of the screen as a refresh rate when another input is received, in response to the other input causing reducing the area. This operation is exemplified in the description of FIG. 12.

FIG. 12 is a flowchart illustrating a method for maintaining a refresh rate while an area is reduced according to an embodiment of the disclosure.

Referring to FIG. 12, in operation 1201, the processor 501 may display a screen. For example, the screen may be displayed on an area (e.g., the area 170) visible from the front side of the housing 130. For example, the screen may be displayed in a state of the electronic device 100 capable of reducing the area. As a non-limiting example, the screen may be displayed in the state 190. As a non-limiting example, the screen may be displayed in the second state exemplified in the description of FIGS. 2A to 2D, 3A, 3B, 4A, and 4B. For example, the screen may be displayed in a state of the electronic device 100 distinguished from the state 180.

In operation 1203, the processor 501 may receive another input for reducing the area while the screen is displayed on the area. For example, the other input may be a counter input of the input received in operation 603.

In operation 1205, the processor 501 may control the actuator 503 to move the second housing part 120 with respect to the first housing part 110, in response to the other input. For example, a direction of movement of the second housing part 120 in operation 1205 may be opposite to a direction of movement of the second housing part 120 in operation 605. For example, the processor 501 may control the PMIC to provide, to the actuator 503, power to move the second housing part 120 with respect to the first housing part 110, in response to the other input.

In operation 1207, the processor 501 may maintain the refresh rate of the screen reduced on the area, while the area is reduced in response to the other input. For example, the refresh rate of the screen may be maintained as the refresh rate of the screen when the other input is received in operation 1203. However, it is not limited thereto. For example, the processor 501 may change the refresh rate of the screen reduced on the area, while the area is reduced in response to the other input, as at least a portion of operations exemplified in the description of FIGS. 6, 7, 8A, 8B, and 9 to 11.

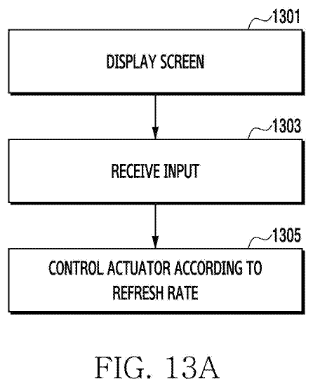

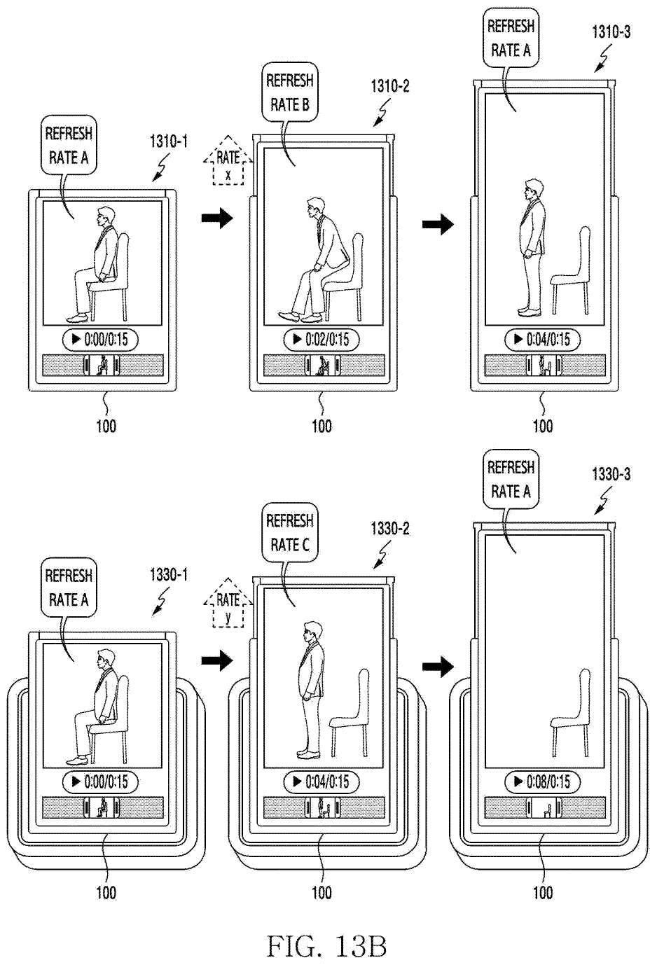

At least a portion of operations exemplified through the above descriptions may be replaced with descriptions of FIGS. 13A, 13B, 14, and 15.

FIG. 13A is a flowchart illustrating a method for controlling an actuator to extend an area to a refresh rate of a screen according to an embodiment of the disclosure.

Referring to FIG. 13A, in operation 1301, the processor 501 may display a screen on an area having a first size (e.g., an area visible from the front side of the housing 130). As a non-limiting example, the processor 501 may display the screen on the area with a first refresh rate or may display the screen on the area with a second refresh rate higher than the first refresh rate. For example, operation 1301 may correspond to operation 601 of FIG. 6.

In operation 1303, the processor 501 may receive an input for extending the area while the screen is displayed on the area. For example, the input may be an input for changing a size of the area from the first size to a second size (the second size being larger than the first size). For example, operation 1303 may correspond to operation 603 of FIG. 6.

In operation 1305, the processor 501 may control the actuator 503 according to a refresh rate of the screen when receiving the input (or before (or immediately before) receiving the input) (or after (or immediately after) receiving the input), based on receiving the input. For example, an operation of the actuator 503 may vary according to a refresh rate used to display the screen on the area having the first size.

For example, the processor 501 may control the actuator 503 to move the second housing part 120 with respect to the first housing part 110 such that the change from the first size to the second size is completed during a first time, in response to the input received while the screen is displayed on the area with the first refresh rate. For example, the processor 501 may control the actuator 503 to move the second housing part 120 with respect to the first housing part 110 such that the change from the first size to the second size is completed during a second time shorter than the first time, in response to the input received while the screen is displayed on the area with the second refresh rate. As a non-limiting example, an average power provided to the actuator 503 for the change from the first size to the second size in response to the input received while the screen is displayed on the area with the first refresh rate may be lower than an average power provided to the actuator 503 for the change from the first size to the second size in response to the input received while the screen is displayed on the area with the second refresh rate.

As a non-limiting example, the controlling of the actuator 503 may be executed (further) based on at least one other parameter distinguished from the refresh rate of the screen. For example, the processor 501 may control the actuator 503 (further) based on a difference between a size of the area when the input in operation 1303 is received and a maximum size of the area (or a size targeted by the input). For example, the processor 501 may control the actuator 503 (further) based on a rate of change of a state of one or more visual objects (e.g., dynamic widget) in the screen.

As described above, the electronic device 100 may change the rate at which the area is extended according to the refresh rate of the screen, instead of adjusting the refresh rate of the screen extended on the area while the area is extended. However, this is merely exemplary. The electronic device 100 may change the rate at which the area is extended and may adjust the refresh rate of the screen extended on the area according to the changed rate. The rate at which the area is extended may be determined according to a state of the electronic device 100. For example, the rate at which the area is extended may be determined according to whether the electronic device 100 is gripped. This operation is exemplified in the description of FIG. 13B.

FIG. 13B illustrates a method for determining a rate at which an area is extended to a state of an electronic device according to an embodiment of the disclosure.

Referring to FIG. 13B, the electronic device 100 may display a screen while being gripped by a user, as indicated by a state 1310-1, a state 1310-2, and a state 1310-3.

For example, the processor 501 may display a screen on an area having a first size (e.g., an area visible from the front side of the housing 130), in the state 1310-1 in which the electronic device 100 is gripped. For example, the processor 501 may display the screen on the area with a refresh rate a (e.g., the refresh rate exemplified in the description of FIG. 7), in the state 1310-1.

For example, the processor 501 may receive an input for extending the area while the screen is displayed on the area with the refresh rate a (or may detect an event causing extending the area). For example, the processor 501 may receive the input as in operation 1303.

For example, the processor 501 may control the actuator 503 to extend the area at a rate determined according to whether the electronic device 100 is gripped, based on receiving the input. For example, the processor 501 may control the actuator 503 to extend the area at a rate X determined based on a state (e.g., the state 1310-1) of the electronic device 100 gripped by a user, in response to the input received in the state 1310-1 (or the event detected in the state 1310-1). For example, the processor 501 may display the screen with a refresh rate b corresponding to the rate X at which the area is extended on the area extended according to the input, as in the state 1310-2 (e.g., a state changed from the state 1310-1), while the area is extended.

For example, the processor 501 may display the screen with the refresh rate a that is a refresh rate before the input is received, after extending of the area is completed as in the state 1310-3 (e.g., a state changed from the state 1310-2).

The electronic device 100 may display a screen while being supported by an external object (e.g., different from a hand of a user), as indicated by the state 1330-1, the state 1330-2, and the state 1330-3. For example, the electronic device 100 may display the screen while not being gripped by the user and being supported by the external object, as indicated by the state 1330-1, the state 1330-2, and the state 1330-3. As a non-limiting example, the electronic device 100 may display the screen while being located on a cradle (e.g., a wireless charging stand) providing power for wirelessly or wiredly charging a rechargeable battery of the electronic device 100, as indicated by the state 1330-1, the state 1330-2, and the state 1330-3.

For example, the processor 501 may display a screen on an area (e.g., an area visible from the front side of the housing 130) having a first size (e.g., corresponding to a size of the area in the state 1310-1), in the state 1330-1. For example, the processor 501 may display the screen on the area with a refresh rate a (e.g., corresponding to the refresh rate a in the state 1310-1 and the state 1310-3), in the state 1330-1.

For example, the processor 501 may receive the input for extending the area while the screen is displayed on the area with the refresh rate a (or may detect an event causing extending the area).

For example, the processor 501 may control the actuator 503 to extend the area at a rate determined according to whether the electronic device 100 is gripped, based on receiving the input. For example, the processor 501 may control the actuator 503 to extend the area at a rate Y determined based on a state of the electronic device 100 not gripped by a user (or a state of the electronic device 100 supported by the external object (e.g., the cradle)) (e.g., the state 1330-1), in response to the input received in a state 1330-1 different from the state 1310-1 (or the event detected in the state 1330-1). For example, the rate Y may be different from the rate X. As a non-limiting example, the rate Y may be lower than the rate X for one or more coils (e.g., available for wireless charging) of the electronic device 100 aligned with one or more coils (e.g., available for wireless charging) of the cradle. For example, the processor 501 may display the screen with a refresh rate c corresponding to the rate Y at which the area is extended on the area extended according to the input, as in the state 1330-2 (e.g., a state changed from the state 1330-1), while the area is extended. For example, since the rate Y is different from the rate X, the refresh rate c may be different from the refresh rate b.

For example, after the extending of the area is completed, the processor 501 may display the screen with the refresh rate a that is a refresh rate before the input is received, as in the state 1330-3 (e.g., a state changed from the state 1330-1).

As described above, the electronic device 100 may enhance a quality of visual information provided through the display 140 by controlling the actuator 503 according to a state of the electronic device 100.

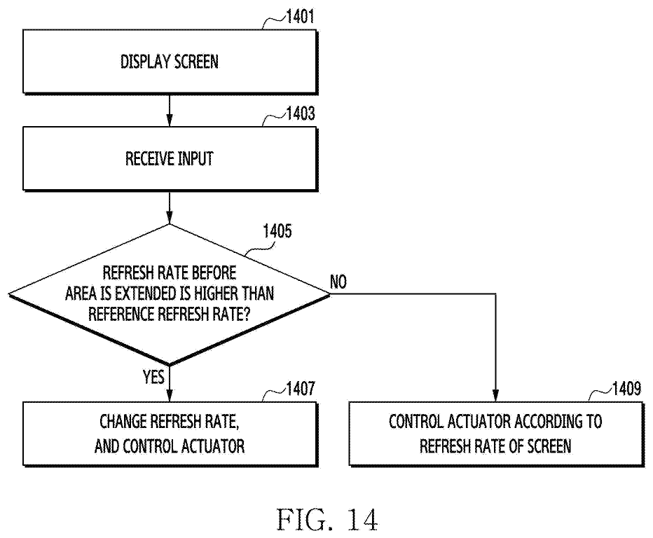

As a non-limiting example, the processor 501 may further cause the electronic device 100 to reduce the refresh rate of the screen while the area is extended, according to the refresh rate of the screen when receiving the input (e.g., the input in operation 1303). This operation is exemplified in the description of FIG. 14.

FIG. 14 is a flowchart illustrating a method for controlling an actuator and a display based on checking a refresh rate of a screen higher than a reference refresh rate, while an area is extended according to an embodiment of the disclosure.

Referring to FIG. 14, in operation 1401, the processor 501 may display a screen on an area (e.g., an area visible from the front side of the housing 130) having a first size. As a non-limiting example, the processor 501 may display the screen on the area with a first refresh rate or may display the screen on the area with a second refresh rate higher than the first refresh rate. For example, operation 1401 may correspond to operation 1301 of FIG. 13A.

In operation 1403, the processor 501 may receive an input for extending the area while the screen is displayed on the area. For example, the input may be an input for changing a size of the area from the first size to a second size (the second size being larger than the first size). For example, operation 1403 may correspond to operation 1303 of FIG. 13A.

In operation 1405, the processor 501 may check or determine or identify whether a refresh rate before the area is extended according to the input is higher than a reference refresh rate. For example, moving the second housing part 120 with respect to the first housing part 110 at a faster rate as the refresh rate before the area is extended according to the input is higher may cause damage of the electronic device 100. As another example, moving the second housing part 120 with respect to the first housing part 110 at a faster rate as the refresh rate before the area is extended according to the input is higher may be impossible due to a limitation of a capability of the actuator 503. As still another example, moving the second housing part 120 with respect to the first housing part 110 at a faster rate as the refresh rate before the area is extended according to the input is higher may cause an excessive load on the actuator 503.

As a non-limiting example, the reference refresh rate may be defined to reduce a probability that the above-described damage, the above-described limitation of the capability of the actuator 503, and/or the above-described excessive load on the actuator 503 occurs. For example, the refresh rate being higher than the reference refresh rate may indicate that driving (or controlling) the actuator 503 to provide a rate corresponding to the refresh rate is not appropriate. For example, the refresh rate being lower than or equal to the reference refresh rate may indicate that driving (or controlling) the actuator 503 to provide a rate corresponding to the refresh rate is appropriate. For example, the processor 501 may execute operation 1407 based on the refresh rate higher than the reference refresh rate. For example, the processor 501 may execute operation 1409 based on the refresh rate lower than or equal to the reference refresh rate.

In operation 1407, on a condition that the refresh rate is higher than the reference refresh rate, the processor 501 may change, to another refresh rate, the refresh rate of the screen extended (or displayed) during the change of the area from the first size to the second size, and may control the actuator 503 to move the second housing part 120 with respect to the first housing part 110 such that the change from the first size to the second size is completed during a reference time. As a non-limiting example, the other refresh rate may be the reference refresh rate. As a non-limiting example, the reference time may be the second time exemplified in the description of FIG. 13A. For example, when the reference time is the second time, the other refresh rate may be the second refresh rate exemplified in the description of FIG. 13A.

In operation 1409, the processor 501 may control the actuator 503 according to the refresh rate on a condition that the refresh rate is lower than or equal to the reference refresh rate. For example, operation 1409 may correspond to operation 1305 of FIG. 13A.

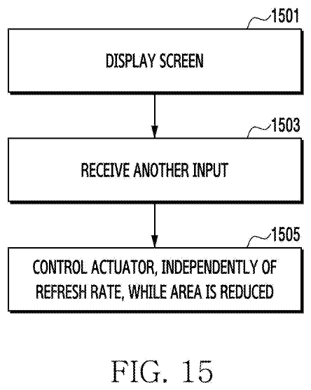

As exemplified in the description of FIG. 13A and the description of FIG. 14, the processor 501 may determine a rate at which the area is extended by using a refresh rate used for displaying the screen when the input is received, in response to an input causing extending the area (e.g., the input in operation 1303)). As a non-limiting example, the processor 501 may maintain a rate of the second housing part 120 moved with respect to the first housing part 110 regardless of a refresh rate of a screen when another input is received, in response to the other input causing reducing the area. This operation is exemplified in the description of FIG. 15.

FIG. 15 is a flowchart illustrating a method for controlling an actuator independently of a refresh rate, while an area is reduced according to an embodiment of the disclosure.

Referring to FIG. 15, in operation 1501, the processor 501 may display a screen. For example, the screen may be displayed on an area (e.g., the area 170) visible from the front side of the housing 130. For example, the screen may be displayed in a state of the electronic device 100 capable of reducing the area. As a non-limiting example, the screen may be displayed in the state 190. As a non-limiting example, the screen may be displayed in the second state exemplified in the description of FIGS. 2A to 2D, 3A, 3B, 4A, and 4B. For example, the screen may be displayed in a state of the electronic device 100 distinguished from the state 180.

In operation 1503, the processor 501 may receive another input for reducing the area while the screen is displayed on the area. For example, the other input may be a counter input of the input received in operation 1303. For example, the other input may be an input for changing a size of the area from the second size to the first size.

In operation 1505, the processor 501 may control the actuator 503 independently of the refresh rate of the screen when the other input is received in operation 1503, while the area is reduced in response to the other input. As a non-limiting example, a time consumed to change a size of the area from the second size to the first size in response to the other input received in operation 1503 while displaying the screen with a refresh rate a may be substantially the same as a time consumed to change the size of the area from the second size to the first size in response to the other input received in operation 1503 while displaying the screen with a refresh rate b. However, it is not limited thereto. For example, the processor 501 may control the actuator 503 according to the refresh rate of the screen displayed on the area, through at least a portion of operations exemplified in the description of FIGS. 13A, 13B, and 14, while the area is reduced in response to the other input. As a non-limiting example, the controlling of the actuator 503 may be executed (further) based on at least one other parameter distinguished from the refresh rate of the screen. For example, the processor 501 may control the actuator 503 (further) based on a difference between a size of the area when the other input in operation 1503 is received and a minimum size of the area (or a size targeted by the other input).

The above descriptions exemplify the electronic device 100 implemented as a slidable electronic device, but the operations exemplified through the above descriptions may be executable in electronic devices having various form factors. For example, an electronic device (e.g., a multi foldable type smartphone or a rollable type smartphone) may include a housing forming an exterior of the electronic device. The electronic device may include a flexible display. The flexible display may be accommodated in the housing. The flexible display may form at least a portion of a front side of the housing. For example, the flexible display may provide a first state in which a first screen having a first size is displayed and a second state in which a second screen having a second size larger than the first size is displayed as at least a portion of the flexible display is moved (or as a posture of at least a portion of the flexible display is changed). For example, when the electronic device is a foldable electronic device, the movement of the at least a portion of the flexible display may include extending (or expanding) an area visible from the front side of the housing as a state of the foldable electronic device is changed from a folded state to an unfolded state. For example, when the electronic device is a slidable electronic device (or a rollable electronic device), the movement of the at least a portion of the flexible display may include moving such that a portion of the flexible display rolled into the housing becomes visible from the front side of the housing.

For example, the electronic device may include a processor accommodated in the housing and operably (or operatively) coupled with the flexible display. The processor may display the first screen having the first size on the flexible display based on a first refresh rate, when the flexible display is in the first state. As a state of the flexible display is switched from the first state to the second state, the processor may display the second screen having the second size on the flexible display based on a second refresh rate corresponding to a rate of the switch from the first state to the second state. The second refresh rate may be higher than the first refresh rate. For example, while the state of the flexible display is switched from the first state to the second state, the processor may display the second screen based on the second refresh rate within a first time interval in which the rate increases and may display the second screen based on a third refresh rate lower than the second refresh rate within a second time interval in which the rate decreases than the first time interval. For example, the second time interval may indicate a time interval in which the switch is performed at a rate lower than a minimum rate within a range in which the rate is changed within the first time interval. As a non-limiting example, the third refresh rate may be the same as the first refresh rate. As a non-limiting example, the third refresh rate may be lower than the first refresh rate. As a non-limiting example, the third refresh rate may be between the first refresh rate and the second refresh rate.

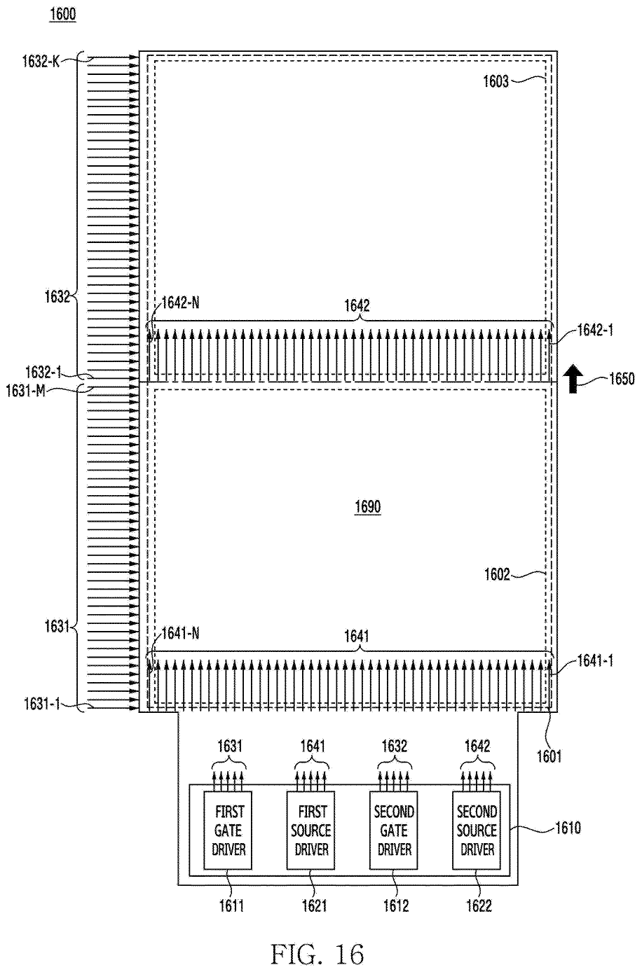

For example, the housing may include a first housing part and a second housing part. The second housing part may be movably coupled to the first housing part so as to be in a contracted position when the flexible display is in the first state and to be in an expanded position (or an extended position) when the flexible display is in the second state. The electronic device including the housing including the first housing part and the second housing part is exemplified in the description of FIG. 16.

FIG. 16 illustrates an example of an operation executed in an electronic device including a housing including a first housing part and a second housing part movably coupled to the first housing part according to an embodiment of the disclosure.

Referring to FIG. 16, an electronic device 1600 may include a first housing part (not illustrated) and a second housing part (not illustrated) movably coupled to the first housing part. For example, the electronic device 1600 may include a flexible display 1690. For example, the second housing part moved with respect to the first housing part may cause a change of a size of an area 1601 of the flexible display 1690 visible from a front side of the housing. For example, the second housing part moved in a direction 1650 with respect to the first housing part may be located at an expanded position (or an extended position). For example, the second housing part moved in a direction opposite to the direction 1650 with respect to the first housing part may be located at a contracted position. For example, the second housing part may be movable with respect to the first housing part between the contracted position and the expanded position. For example, the second housing part may be movably coupled to the first housing part in a direction parallel to a longitudinal direction of a screen displayed through the flexible display 1690.

For example, the area 1601 of the flexible display 1690 may include an area 1602 and an area 1603.

For example, among the area 1602 and the area 1603, the area 1602 may be visible from the front side of the housing when the second housing part is located at the contracted position. For example, among the area 1602 and the area 1603, the area 1603 may be rolled into the housing (e.g., the second housing part) when the second housing part is located at the contracted position. For example, among the area 1602 and the area 1603, the area 1603 may be invisible from the front side of the housing when the second housing part is located at the contracted position. For example, the area 1602 and the area 1603 may be visible from the front side of the housing when the second housing part is located at the expanded position, as illustrated in FIG. 16.

For example, the electronic device 1600 may include a processor operably coupled with the flexible display 1690. For example, the processor may be connected to display driver circuitry 1610 in the flexible display 1690 available for displaying a screen on at least a portion of the area 1601.

For example, the screen displayed by the display driver circuitry 1610 may be displayed on the area 1602 among the area 1602 and the area 1603, when the second housing part is located at the contracted position. For example, the screen may have a first size when the second housing part is located at the contracted position. A state of the flexible display 1690 in which the screen has the first size may be referred to as a first state. The screen having the first size may be referred to as a first screen.

For example, the screen displayed by the display driver circuitry 1610 may be displayed on the area 1602 and the area 1603 when the second housing part is located at the expanded position. For example, the screen may have a second size larger than the first size when the second housing part is located at the expanded position. A state of the flexible display 1690 in which the screen has the second size may be referred to as a second state. The screen having the second size may be referred to as a second screen.

For example, the display driver circuitry 1610 may include a first gate driver 1611, a second gate driver 1612, a first source driver 1621, and a second source driver 1622 available for displaying the first screen or the second screen.

For example, the first gate driver 1611 may be available for applying a gate voltage to each of first sub-pixels located in the area 1602. For example, the first gate driver 1611 may transmit signals 1631 each having a gate voltage to the first sub-pixels. For example, the signals 1631 may be transmitted to the first sub-pixels through first scan lines connected to the first sub-pixels. For example, the first source driver 1621 may be available for applying a data voltage to each of the first sub-pixels. For example, the first source driver 1621 may transmit signals 1641 each having a data voltage to the first sub-pixels. For example, the signals 1641 may be transmitted to the first sub-pixels through first data lines connected to the first sub-pixels.

For example, the second gate driver 1612 may be available for applying a gate voltage to each of second sub-pixels located in the area 1603. For example, the second gate driver 1612 may transmit signals 1632 each having a gate voltage to the second sub-pixels. For example, the signals 1632 may be transmitted to the second sub-pixels through second scan lines connected to the second sub-pixels. For example, the second source driver 1622 may be available for applying a data voltage to each of the second sub-pixels. For example, the second source driver 1622 may transmit signals 1642 each having a data voltage to the second sub-pixels. For example, the signals 1642 may be transmitted to the second sub-pixels through second data lines connected to the second sub-pixels.

For example, the processor may cause the electronic device 1600 to display the first screen in the first state. For example, the processor may provide first data regarding a first image corresponding to the first screen to the display driver circuitry 1610.

For example, the display driver circuitry 1610 may display the first screen on the area 1602, by using the first data. For example, the first screen may be displayed with a first refresh rate. For example, the display driver circuitry 1610 may display the first screen on the area 1602, by transmitting signals 1641 obtained through the first data to the first sub-pixels using the first source driver 1621 according to the first refresh rate and transmitting signals 1631 to the first sub-pixels using the first gate driver 1611 according to the first refresh rate. For example, the signals 1641 may be sequentially transmitted from a signal 1641-1 to a signal 1641-N(N is a natural number greater than 1). For example, the signals 1631 may be transmitted from a signal 1631-1 to a signal 1631-M (M is a natural number greater than 1).

For example, the processor may receive an input causing moving a position of the second housing part from the contracted position to the expanded position (e.g., movement of the second housing part in the direction 1650) (or an input switching the first state to the second state), while the first screen is displayed with the first refresh rate. For example, the processor may execute operations for displaying the second screen on the area 1602 and the area 1603, in response to the input. For example, the processor may cause the electronic device 1600 to display a portion of the second screen on the area 1603. For example, the processor may provide second data regarding a second image corresponding to the second screen to the display driver circuitry 1610.

For example, the display driver circuitry 1610 may display the second screen on the area 1602 and the area 1603 while the second housing part is moved in the direction 1650 by using the second data. For example, another portion of the screen displayed on the area 1602 may have the first refresh rate, and the portion of the screen displayed on the area 1603 may have a second refresh rate higher than the first refresh rate.

For example, the display driver circuitry 1610 may display the other portion of the second screen on the area 1602 with the first refresh rate, by transmitting signals 1641 obtained through a portion of the second data to the first sub-pixels by using the first source driver 1621 according to the first refresh rate and transmitting signals 1631 to the first sub-pixels by using the first gate driver 1611 according to the first refresh rate. For example, the signals 1641 may be sequentially transmitted from a signal 1641-1 to a signal 1641-N. For example, the signals 1631 may be transmitted from a signal 1631-1 to a signal 1631-M.

For example, the display driver circuitry 1610 may display the portion of the second screen on the area 1603 with the second refresh rate, by transmitting signals 1642 obtained through another portion of the second data to the second sub-pixels by using the second source driver 1622 according to the second refresh rate and transmitting signals 1632 to the second sub-pixels by using the second gate driver 1612 according to the second refresh rate. For example, the signals 1642 may be sequentially transmitted from a signal 1642-1 to a signal 1642-N. For example, the signals 1632 may be transmitted from a signal 1632-1 to a signal 1632-K (K is a natural number greater than 1).

As described above, the electronic device 1600 may display the other portion of the second screen on the area 1602 with the first refresh rate while the second housing part is moved and display the portion of the second screen on the area 1603 with the second refresh rate while the second housing part is moved, by using a plurality of gate drivers and a plurality of source drivers included in the flexible display 1690.

As another example, the processor may receive an input causing moving a position of the second housing part from the contracted position to the expanded position (e.g., movement of the second housing part in the direction 1650) (or an input switching the first state to the second state), while the first screen is displayed with the first refresh rate. For example, the processor may execute operations for displaying the second screen on the area 1602 and the area 1603, in response to the input. For example, the processor may cause the electronic device 1600 to display a portion of the second screen on the area 1603. For example, the processor may provide second data regarding a second image corresponding to the second screen to the display driver circuitry 1610.

For example, the display driver circuitry 1610 may display the second screen on the area 1602 and the area 1603, while the second housing part is moved in the direction 1650, by using the second data. For example, the other portion of the screen displayed on the area 1602 may have the first refresh rate, and the portion of the screen displayed on the area 1603 may have a second refresh rate higher than the first refresh rate.

For example, the display driver circuitry 1610 may display the other portion of the second screen on the area 1602 with the second refresh rate, by transmitting signals 1641 obtained through a portion of the second data to the first sub-pixels by using the first source driver 1621 according to the second refresh rate and transmitting signals 1631 to the first sub-pixels by using the first gate driver 1611 according to the second refresh rate. For example, the signals 1641 may be sequentially transmitted from a signal 1641-1 to a signal 1641-N. For example, the signals 1631 may be transmitted from a signal 1631-1 to a signal 1631-M.

For example, the display driver circuitry 1610 may display the portion of the second screen on the area 1603 with the second refresh rate, by transmitting signals 1642 obtained through another portion of the second data to the second sub-pixels by using the second source driver 1622 according to the second refresh rate and transmitting signals 1632 to the second sub-pixels by using the second gate driver 1612 according to the second refresh rate. For example, the signals 1642 may be sequentially transmitted from a signal 1642-1 to a signal 1642-N. For example, the signal 1642-1 and the signal 1631-1 may be transmitted simultaneously. For example, the signals 1632 may be transmitted from a signal 1632-1 to a signal 1632-K (K is a natural number greater than 1). For example, the signal 1632-1 and the signal 1631-1 may be transmitted simultaneously.

As described above, the electronic device 1600 may display the other portion of the second screen on the area 1602 with the second refresh rate while the second housing part is moved and may display the portion of the second screen on the area 1603 with the second refresh rate while the second housing part is moved, by using a plurality of gate drivers and a plurality of source drivers included in the flexible display 1690. For example, the electronic device 1600 may prevent a quality of a screen displayed while the second housing part is moved from being reduced, by including the plurality of gate drivers and the plurality of source drivers. For example, the electronic device 1600 may reduce a probability that flickering occurs in the screen, by further driving the second gate driver 1612 and/or the second source driver 1622 while the screen is extended.

As a non-limiting example, the area of the flexible display 1690 visible from the front side of the housing may be extended not only in the direction 1650 but also in a direction perpendicular to the direction 1650. For example, the processor (or the display driver circuitry 1610) may differently change a refresh rate of a screen displayed on the area, according to whether a direction in which the area is extended is the direction 1650 or the direction perpendicular to the direction 1650. For example, the processor may change the refresh rate of the screen from a first refresh rate to a second refresh rate higher than the first refresh rate based on the area extended in the direction 1650, and change the refresh rate of the screen to a third refresh rate higher than the first refresh rate and lower than the second refresh rate based on the area extended in the direction perpendicular to the direction 1650.

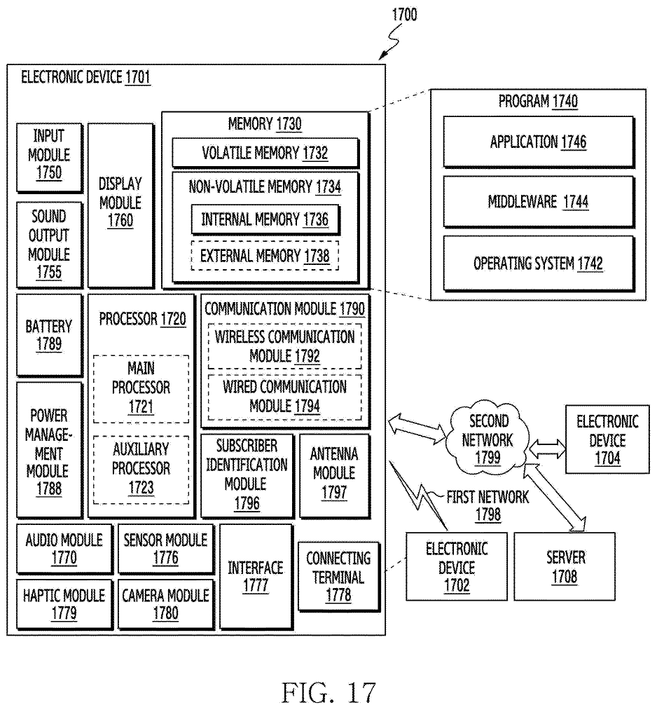

The above-exemplified operations may be executed through components of an electronic device 1701 exemplified below. For example, the processor 501 or the processor of the electronic device 1600 may correspond to at least a portion of a processor 1720 of FIG. 17, the memory 502 may correspond to at least a portion of memory 1730 of FIG. 17, the display 140 or the flexible display 1690 may correspond to at least a portion of a display module 1760 of FIG. 17, and the illuminance sensor 504 may correspond to at least a portion of a sensor module 1776 of FIG. 17.

FIG. 17 is a block diagram illustrating an electronic device 1701 in a network environment 1700 according to an embodiment of the disclosure. Referring to FIG. 17, the electronic device 1701 in the network environment 1700 may communicate with an electronic device 1702 via a first network 1798 (e.g., a short-range wireless communication network), or at least one of an electronic device 1704 or a server 1708 via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber identification module (SIM) 1796, or an antenna module 1797. In some embodiments, at least one of the components (e.g., the connecting terminal 1778) may be omitted from the electronic device 1701, or one or more other components may be added in the electronic device 1701. In some embodiments, some of the components (e.g., the sensor module 1776, the camera module 1780, or the antenna module 1797) may be implemented as a single component (e.g., the display module 1760).

The processor 1720 may execute, for example, software (e.g., a program 1740) to control at least one other component (e.g., a hardware or software component) of the electronic device 1701 coupled with the processor 1720, and may perform various data processing or computation. According to an embodiment, as at least part of the data processing or computation, the processor 1720 may store a command or data received from another component (e.g., the sensor module 1776 or the communication module 1790) in volatile memory 1732, process the command or the data stored in the volatile memory 1732, and store resulting data in non-volatile memory 1734. According to an embodiment, the processor 1720 may include a main processor 1721 (e.g., a central processing unit (CPU) or an application processor (AP)), or an auxiliary processor 1723 (e.g., a graphics processing unit (GPU), a neural processing unit (NPU), an image signal processor (ISP), a sensor hub processor, or a communication processor (CP)) that is operable independently from, or in conjunction with, the main processor 1721. For example, when the electronic device 1701 includes the main processor 1721 and the auxiliary processor 1723, the auxiliary processor 1723 may be adapted to consume less power than the main processor 1721, or to be specific to a specified function. The auxiliary processor 1723 may be implemented as separate from, or as part of the main processor 1721.

The auxiliary processor 1723 may control at least some of functions or states related to at least one component (e.g., the display module 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). According to an embodiment, the auxiliary processor 1723 (e.g., an image signal processor or a communication processor) may be implemented as part of another component (e.g., the camera module 1780 or the communication module 1790) functionally related to the auxiliary processor 1723. According to an embodiment, the auxiliary processor 1723 (e.g., the neural processing unit) may include a hardware structure specified for artificial intelligence model processing. An artificial intelligence model may be generated by machine learning. Such learning may be performed, e.g., by the electronic device 1701 where the artificial intelligence is performed or via a separate server (e.g., the server 1708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734.

The program 1740 may be stored in the memory 1730 as software, and may include, for example, an operating system (OS) 1742, middleware 1744, or an application 1746.

The input module 1750 may receive a command or data to be used by another component (e.g., the processor 1720) of the electronic device 1701, from the outside (e.g., a user) of the electronic device 1701. The input module 1750 may include, for example, a microphone, a mouse, a keyboard, a key (e.g., a button), or a digital pen (e.g., a stylus pen).

The sound output module 1755 may output sound signals to the outside of the electronic device 1701. The sound output module 1755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1760 may visually provide information to the outside (e.g., a user) of the electronic device 1701. The display module 1760 may include, for example, a display, a hologram device, or a projector and control circuitry to control a corresponding one of the display, hologram device, and projector. According to an embodiment, the display module 1760 may include a touch sensor adapted to detect a touch, or a pressure sensor adapted to measure the intensity of force incurred by the touch.

The audio module 1770 may convert a sound into an electrical signal and vice versa. According to an embodiment, the audio module 1770 may obtain the sound via the input module 1750, or output the sound via the sound output module 1755 or a headphone of an external electronic device (e.g., an electronic device 1702) directly (e.g., wiredly) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly (e.g., wiredly) or wirelessly. According to an embodiment, the interface 1777 may include, for example, a high definition multimedia interface (HDMI), a universal serial bus (USB) interface, a secure digital (SD) card interface, or an audio interface.

A connecting terminal 1778 may include a connector via which the electronic device 1701 may be physically connected with the external electronic device (e.g., the electronic device 1702). According to an embodiment, the connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or electrical stimulus which may be recognized by a user via his tactile sensation or kinesthetic sensation. According to an embodiment, the haptic module 1779 may include, for example, a motor, a piezoelectric element, or an electric stimulator.

The camera module 1780 may capture a still image or moving images. According to an embodiment, the camera module 1780 may include one or more lenses, image sensors, image signal processors, or flashes.

The power management module 1788 may manage power supplied to the electronic device 1701. According to an embodiment, the power management module 1788 may be implemented as at least part of, for example, a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the application processor (AP)) and supports a direct (e.g., wired) communication or a wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as Bluetooth™ wireless-fidelity (Wi-Fi) direct, or infrared data association (IrDA)) or the second network 1799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The wireless communication module 1792 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1792 may support a high-frequency band (e.g., the millimeter wave (mmWave) band) to achieve, e.g., a high data transmission rate. The wireless communication module 1792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20 Gbps or more) for implementing eMBB, loss coverage (e.g., 1764 dB or less) for implementing mMTC, or user plane (U-plane) latency (e.g., 0.5 ms or less for each of downlink (DL) and uplink (UL), or a round trip of 17 ms or less) for implementing URLLC.

The antenna module 1797 may transmit or receive a signal or power to or from the outside (e.g., the external electronic device) of the electronic device 1701. According to an embodiment, the antenna module 1797 may include an antenna including a radiating element composed of a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in the communication network, such as the first network 1798 or the second network 1799, may be selected, for example, by the communication module 1790 (e.g., the wireless communication module 1792) from the plurality of antennas. The signal or the power may then be transmitted or received between the communication module 1790 and the external electronic device via the selected at least one antenna. According to an embodiment, another component (e.g., a radio frequency integrated circuit (RFIC)) other than the radiating element may be additionally formed as part of the antenna module 1797.

According to various embodiments, the antenna module 1797 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the electronic devices 1702 or 1704 may be a device of a same type as, or a different type, from the electronic device 1701. According to an embodiment, all or some of operations to be executed at the electronic device 1701 may be executed at one or more of the external electronic devices 1702, 1704, or 1708. For example, if the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra low-latency services using, e.g., distributed computing or mobile edge computing. In another embodiment, the external electronic device 1704 may include an internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., smart home, smart city, smart car, or healthcare) based on fifth generation (5G) communication technology or IoT-related technology.

As described above, a slidable electronic device (e.g., the electronic device 100) includes a housing (e.g., the housing 130) including a first housing part (e.g., the first housing part 110) and a second housing part (e.g., the second housing part 120) movably engaged with the first housing part, an actuator (e.g., the actuator 503) configured to move the second housing part with respect to the first housing part, and a flexible display (e.g., the display 140) coupled to the first housing part and the second housing part such that a size of an area visible from a front side of the housing is changed as the second housing part is moved with respect to the first housing part. The slidable electronic device further includes memory storing instructions, when executed in the slidable electronic device, to receive an input for extending the area while a screen is displayed on the area, control the actuator to move the second housing part with respect to the first housing part in response to the input, and cause the flexible display to change a refresh rate of the screen extended on the area according to a rate at which the area is extended, while the area is extended as the second housing part is moved with respect to the first housing part in response to the input.

For example, the memory may store instructions that, when executed in the slidable electronic device, cause the flexible display to change the refresh rate of the screen by determining, as the refresh rate of the screen, a reference refresh rate corresponding to the rate among a plurality of reference refresh rates available in the slidable electronic device while the area is extended.

For example, the memory may store instructions that, when executed in the slidable electronic device, cause the flexible display to change the refresh rate of the screen, by changing a timing of transmitting, to the flexible display, an image for displaying the screen according to the rate while the area is extended.

For example, the memory may store instructions that, when executed in the slidable electronic device, cause the flexible display to change the refresh rate of the screen according to a type of a software application providing contents in the screen and the rate, while the area is extended.

For example, the slidable electronic device includes an illuminance sensor (e.g., the illuminance sensor 504). For example, the memory may store instructions that, when executed in the slidable electronic device, cause the flexible display to change the refresh rate of the screen according to an illuminance around the slidable electronic device measured through the illuminance sensor and the rate, while the area is extended.

For example, the memory may store instructions that, when executed in the slidable electronic device, cause the flexible display to change the refresh rate of the screen according to a brightness level of the screen and the rate, while the area is extended.

For example, the memory may store instructions that, when executed in the slidable electronic device, cause the flexible display to change the refresh rate of the screen according to a size of the area and the rate, while the area is extended.

For example, the memory may store instructions that, when executed in the slidable electronic device, cause the flexible display to restore the refresh rate of the screen to a refresh rate utilized before the input is received, based on completing to extend the area according to the input.

For example, the slidable electronic device includes a hall sensor integrated circuit (IC) configured to obtain data regarding a distance moved by the second housing part with respect to the first housing part. For example, the memory may store instructions that, when executed in the slidable electronic device, measure the rate by using the data obtained through the hall sensor IC, while the area is extended.

For example, the actuator may include a motor encoder. For example, the memory may store instructions that, when executed in the slidable electronic device, measure the rate by using data obtained through the motor encoder, while the area is extended.

For example, the memory may store instructions that, when executed in the slidable electronic device, measure the rate, by using a change in capacitance caused in the flexible display, while the area is extended.

For example, the refresh rate of the screen when the rate is a first rate while the area is extended may be higher than the refresh rate of the screen when the rate is a second rate lower than the first rate while the area is extended.

As described above, a slidable electronic device (e.g., the electronic device 100) includes a housing (e.g., the housing 130) including a first housing part (e.g., the first housing part 110) and a second housing part (e.g., the second housing part 120) movably engaged with the first housing part, an actuator (e.g., the actuator 503) configured to move the second housing part with respect to the first housing part, and a flexible display (e.g., the display 140) coupled to the first housing part and the second housing part such that a size of an area visible from a front side of the housing is changed as the second housing part is moved with respect to the first housing part. The slidable electronic device further includes memory storing instructions to receive, while a screen is displayed on the area having a first size, an input for changing a size of the area from the first size to a second size larger than the first size, control the actuator to move the second housing part with respect to the first housing part such that the change from the first size to the second size is completed during a first time in response to the input received while the screen is displayed on the area with a first refresh rate, and control the actuator to move the second housing part with respect to the first housing part such that the change from the first size to the second size is completed during a second time shorter than the first time in response to the input received while the screen is displayed on the area with a second refresh rate higher than the first refresh rate.

For example, an average power provided to the actuator for the change from the first size to the second size in response to the input received while the screen is displayed on the area with the first refresh rate may be lower than an average power provided to the actuator for the change from the first size to the second size in response to the input received while the screen is displayed on the area with the second refresh rate.

For example, the memory may store instructions to, when executed in the slidable electronic device, control the actuator to move the second housing part with respect to the first housing part such that the change from the first size to the second size is completed during the second time in response to the input received while the screen is displayed on the area with a third refresh rate higher than the first refresh rate and the second refresh rate, and change the refresh rate of the screen to a refresh rate lower than the third refresh rate during the change from the first size to the second size.

As described above, a non-transitory computer-readable storage medium may store one or more programs. The one or more programs includes instructions to, when executed by a slidable electronic device including a housing including a first housing part and a second housing part movably engaged with the first housing part, an actuator configured to move the second housing part with respect to the first housing part, and a flexible display coupled to the first housing part and the second housing part such that a size of an area visible from a front side of the housing is changed as the second housing part is moved with respect to the first housing part, cause the slidable electronic device to receive an input for extending the area while a screen is displayed on the area, control the actuator to move the second housing part with respect to the first housing part in response to the input, and cause the flexible display to change a refresh rate of the screen extended on the area according to a rate at which the area is extended, while the area is extended as the second housing part is moved with respect to the first housing part in response to the input.

For example, the one or more programs may include instructions that, when executed by the slidable electronic device, cause the slidable electronic device to cause the flexible display to change the refresh rate of the screen, by determining, as the refresh rate of the screen, a reference refresh rate corresponding to the rate among a plurality of reference refresh rates available in the slidable electronic device while the area is extended.

For example, the one or more programs may include instructions that, when executed by the slidable electronic device, cause the slidable electronic device to cause the flexible display to change the refresh rate of the screen, by changing a timing of transmitting an image for displaying the screen to the flexible display according to the rate while the area is extended.

For example, the one or more programs may include instructions that, when executed by the slidable electronic device, cause the slidable electronic device to cause the flexible display to change the refresh rate of the screen according to a type of a software application providing contents in the screen and the rate, while the area is extended.

For example, the one or more programs may include instructions that, when executed by the slidable electronic device, cause the slidable electronic device to cause the flexible display to change the refresh rate of the screen according to an illuminance around the slidable electronic device and the rate, while the area is extended.

As described above, an electronic device includes a housing and a flexible display accommodated in the housing. The flexible display may be configured to provide a first state in which a first screen having a first size is displayed and a second state in which a second screen having a second size larger than the first size is displayed as at least a portion of the flexible display is moved. The electronic device includes a processor accommodated in the housing and operably connected to the flexible display. The processor may be configured to display the first screen having the first size on the flexible display based on a first refresh rate when the flexible display is in the first state, and display the second screen having the second size on the flexible display based on a second refresh rate corresponding to a rate of the switch from the first state to the second state as a state of the flexible display is switched from the first state to the second state.

For example, the second refresh rate may be higher than the first refresh rate.

For example, the processor may be configured to display the second screen based on the second refresh rate within a first time interval in which the rate increases while a state of the flexible display is switched from the first state to the second state, and display the second screen based on a third refresh rate lower than the second refresh rate within a second time interval in which the rate decreases than the first time interval.

For example, the housing may include a first housing part and a second housing part, and the second housing part may be movably coupled to the first housing part to be in a contracted position when the flexible display is in the first state and to be in an expanded position when the flexible display is in the second state.

For example, the second housing part may be movably coupled to the first housing part in a direction parallel to a longitudinal direction of the second screen.

For example, the flexible display may include a plurality of scan lines extending in a first direction and a plurality of data lines extending in a second direction, and the second housing part may be movably coupled to the first housing part in a direction parallel to the second direction.

For example, the electronic device may include an actuator accommodated in the housing and configured to provide a force for moving the housing between the contracted position and the expanded position. The processor may be configured to display the second screen as a rate of the actuator is switched from a first rate to a second rate.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1740) including one or more instructions that are stored in a storage medium (e.g., internal memory 1736 or external memory 1738) that is readable by a machine (e.g., the electronic device 1701). For example, a processor (e.g., the processor 1720) of the machine (e.g., the electronic device 1701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A slidable electronic device comprising:
memory, including one or more storage media, storing instructions;
a housing including a first housing part and a second housing part that is movably engaged with the first housing part;
an actuator configured to move the second housing part with respect to the first housing part;
a flexible display coupled to the first housing part and the second housing part such that a size of an area of the flexible display that is visible from a front side of the housing changes as the second housing part is moved with respect to the first housing part; and
one or more processors,
wherein the instructions, when executed by the one or more processors individually or collectively, cause the slidable electronic device to:
receive an input for extending the area, while a screen is displayed on the area,
control, in response to the input, the actuator to move the second housing part with respect to the first housing part, and
cause, while the area is extended in accordance with the second housing part being moved with respect to the first housing part in response to the input, the flexible display to change a refresh rate of the screen that is extended on the area, according to a rate at which the area is extended.

2. The slidable electronic device of claim 1, wherein the instructions, when executed by the one or more processors individually or collectively, further cause the slidable electronic device to cause the flexible display to change the refresh rate of the screen by determining, while the area is extended, the refresh rate of the screen as a reference refresh rate corresponding to the rate from among a plurality of reference refresh rate available in the slidable electronic device.

3. The slidable electronic device of claim 1, wherein the instructions, when executed by the one or more processors individually or collectively, further cause the slidable electronic device to cause the flexible display to change the refresh rate of the screen by changing, while the area is extended, a timing to transmit, to the flexible display, an image for display of the screen according to the rate.

4. The slidable electronic device of claim 1, wherein the instructions, when executed by the one or more processors individually or collectively, further cause the slidable electronic device to cause the flexible display to change, while the area is extended, the refresh rate of the screen according to the rate and a type of a software application providing contents of the screen.

5. The slidable electronic device of claim 1, further comprising:
an illuminance sensor,
wherein the instructions, when executed by the one or more processors individually or collectively, further cause the slidable electronic device to cause the flexible display to change, while the area is extended, the refresh rate of the screen according to the rate and an illuminance around the slidable electronic device measured through the illuminance sensor.

6. The slidable electronic device of claim 1, wherein the instructions, when executed by the one or more processors individually or collectively, further cause the slidable electronic device to cause the flexible display to change, while the area is extended, the refresh rate of the screen according to the rate and a brightness of the screen.

7. The slidable electronic device of claim 1, wherein the instructions, when executed by the one or more processors individually or collectively, further cause the slidable electronic device to cause the flexible display to change, while the area is extended, the refresh rate of the screen according to the rate and a size of the area.

8. The slidable electronic device of claim 1, wherein the instructions, when executed by the one or more processors individually or collectively, further cause the slidable electronic device to cause the flexible display to restore the refresh rate of the screen to a refresh rate utilized before the input is received, in response to completing to extend the area according to the input.

9. The slidable electronic device of claim 1, further comprising:
a hall sensor integrated circuit (IC) configured to obtain data regarding a distance moved by the second housing part with respect to the first housing part,
wherein the instructions, when executed by the one or more processors individually or collectively, further cause the slidable electronic device to measure the rate by using the data obtained through the hall sensor IC, while the area is extended.

10. The slidable electronic device of claim 1,
wherein the actuator includes a motor encoder, and
wherein the instructions, when executed by the one or more processors individually or collectively, further cause the slidable electronic device to measure the rate by using data obtained through the motor encoder, while the area is extended.

11. The slidable electronic device of claim 1, wherein the instructions, when executed by the one or more processors individually or collectively, further cause the slidable electronic device to measure the rate by using a change in capacitance caused in the flexible display, while the area is extended.

12. The slidable electronic device of claim 1, wherein the refresh rate of the screen when the rate is a first rate is higher than the refresh rate of the screen when the rate is a second rate lower than the first rate.

13. A slidable electronic device comprising:
memory, including one or more storage media, storing instructions;
a housing including a first housing part and a second housing part that is movably engaged with the first housing part;
an actuator configured to move the second housing part with respect to the first housing part;
a flexible display coupled to the first housing part and the second housing part such that a size of an area of the flexible display that is visible from a front side of the housing changes as the second housing part is moved with respect to the first housing part; and
one or more processors,
wherein the instructions, when executed by the one or more processors individually or collectively, cause the slidable electronic device to:
receive, while a screen is displayed on the area with a first size, an input for changing a size of the area from the first size to a second size larger than the first size,
in response to the input received while the screen is displayed on the area in a first refresh rate, control the actuator to move the second housing part with respect to the first housing part such that the change from the first size to the second size is completed during a first time, and
in response to the input received while the screen is displayed on the area in a second refresh rate higher than the first refresh rate, control the actuator to move the second housing part with respect to the first housing part such that the change from the first size to the second size is completed during a second time shorter than the first time.

14. The slidable electronic device of claim 13, wherein average power provided to the actuator for the change from the first size to the second size in response to the input received while the screen is displayed on the area in the first refresh rate is lower than average power provided to the actuator for the change from the first size to the second size in response to the input received while the screen is displayed on the area in the second refresh rate.

15. The slidable electronic device of claim 13, wherein the instructions, when executed by the one or more processors individually or collectively, further cause the slidable electronic device to:
in response to the input received while the screen is displayed on the area in a third refresh rate higher than the first refresh rate and the second refresh rate:
control the actuator to move the second housing part with respect to the first housing part such that the change from the first size to the second size is completed during the second time, and
change, during the change from the first size to the second size, a refresh rate of the screen to a refresh rate lower than the third refresh rate.

16. One or more non-transitory computer readable storage media storing one or more computer programs computer-executable instructions when, when executed by one or more processors of a slidable electronic device including a housing including a first housing part and a second housing part that is movably engaged with the first housing part, an actuator configured to move the second housing part with respect to the first housing part, and a flexible display coupled to the first housing part and the second housing part such that a size of an area of the flexible display that is visible from a front side of the housing changes as the second housing part is moved with respect to the first housing part individually or collectively, cause the slidable electronic device to perform operations, the operations comprising:
receiving an input for extending the area, while a screen is displayed on the area;
controlling, in response to the input, the actuator to move the second housing part with respect to the first housing part; and
causing, while the area is extended in accordance with the second housing part being moved with respect to the first housing part in response to the input, the flexible display to change a refresh rate of the screen that is extended on the area, according to a rate at which the area is extended.

17. The one or more non-transitory computer readable storage media of claim 16, the operations comprising:
causing the flexible display to change the refresh rate of the screen by determining, while the area is extended, the refresh rate of the screen as a reference refresh rate corresponding to the rate from among a plurality of reference refresh rate available in the slidable electronic device.

18. The one or more non-transitory computer readable storage media of claim 16, the operations comprising:
causing the flexible display to change the refresh rate of the screen by changing, while the area is extended, a timing to transmit, to the flexible display, an image for display of the screen according to the rate.

19. The one or more non-transitory computer readable storage media of claim 16, the operations comprising:
causing the flexible display to change, while the area is extended, the refresh rate of the screen according to the rate and a type of a software application providing contents of the screen.

20. The one or more non-transitory computer readable storage media of claim 16, the operations comprising:
causing the flexible display to change, while the area is extended, the refresh rate of the screen according to the rate and an illuminance around the slidable electronic device.
